(19) United States
(12) Patent Application Publication
(10) Pub. No.: US 2026/0267345 A1
(43) Pub. Date: Sep. 10, 2026

(54) LIFT DEVICE WITH OBSTACLE DETECTION AND PATH SELECTION SYSTEM

(71) Applicant: Oshkosh Corporation, Oshkosh, WI (US)

(72) Inventors: David Wolf, Oshkosh, WI (US); Maximillian Panoff, Oshkosh, WI (US); Kyle Bush, Oshkosh, WI (US); Skylar McLean, Oshkosh, WI (US); Prabhu Shankar, Oshkosh, WI (US); Milan Klimes, Oshkosh, WI (US)

(73) Assignee: Oshkosh Corporation, Oshkosh, WI (US)

(21) Appl. No.: 19/559,767

(22) Filed: Mar. 6, 2026

Related U.S. Application Data
(60) Provisional application No. 63/768,838, filed on Mar. 7, 2025.

(51) Int. Cl. G05D 1/622; B66F 17/00; G05D 1/242; G05D 1/243; G05D 1/245; G05D 105/22

(52) U.S. Cl. CPC G05D 1/622; B66F 17/006; G05D 1/242; G05D 1/243; G05D 1/245; G05D 2105/22

(57) ABSTRACT

An obstacle detection system includes a lift device including: a chassis; a drivetrain coupled to the chassis and configured to propel the lift device; an implement; a lift assembly coupled to the chassis and the implement, the lift assembly configured to raise the implement relative to the chassis; and a sensor. One or more processing circuits are configured to: receive sensor data from the sensor; detect an obstacle near the lift device based on the sensor data; determine, responsive to the obstacle being near the lift device, a path to a destination for the lift device that avoids interacting with the obstacle; and control at least one of the drivetrain or the lift assembly to move the lift device on the path to the destination.

### CROSS REFERENCE TO RELATED PATENT APPLICATION

This application claims the benefit of and priority to U.S. Provisional Patent Application No. 63/768,838, filed on Mar. 7, 2025, the entire disclosure of which is hereby incorporated by reference herein.

### BACKGROUND

The present disclosure relates to lift devices. More specifically, the present disclosure relates to controlling lift devices.

### SUMMARY

At least one embodiment relates to an obstacle detection system including a lift device including: a chassis; a drivetrain coupled to the chassis and configured to propel the lift device; an implement; a lift assembly coupled to the chassis and the implement, the lift assembly configured to raise the implement relative to the chassis; and a sensor. One or more processing circuits are configured to: receive sensor data from the sensor; detect an obstacle near the lift device based on the sensor data; determine, responsive to the obstacle being near the lift device, a path to a destination for the lift device that avoids interacting with the obstacle; and control at least one of the drivetrain or the lift assembly to move the lift device on the path to the destination.

Another embodiment relates to a lift device, including: a base assembly configured to propel the lift device; a lift assembly coupled to the base assembly; a platform assembly coupled to the lift assembly and including a rail coupled to a deck; a first sensor coupled to the rail and configured to detect a first obstacle; a second sensor coupled to the deck and configured to detect a second obstacle; and a controller operatively coupled to the first sensor and the second sensor. The lift assembly is configured to raise the platform assembly relative to the base assembly. The controller is configured to: receive a command to control at least one of the base assembly or the lift assembly to move the lift device along a first path; determine a second path for the lift device that is different from the first path in response to at least one of (a) the first sensor detecting the first obstacle or (b) the second sensor detecting the second obstacle; and control at least one of the base assembly or the lift assembly to move the lift device along the second path.

Another embodiment relates to a method including: receiving, by one or more processing circuits, sensor data from one or more sensors disposed on a lift device; detecting, by the one or more processing circuits, an obstacle near the lift device based on the sensor data; determining, by the one or more processing circuits, responsive to the obstacle being near the lift device, a path to a destination for the lift device that avoids interacting with the obstacle; and monitoring, by the one or more processing circuits, the lift device to determine whether there is a collision on the path between the lift device and the obstacle or another obstacle.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a perspective view of a lift device, according to some embodiments.

FIG. 2 is a perspective view of a base of the lift device of FIG. 1, according to some embodiments.

FIG. 3 is a perspective view of an axle assembly of the lift device of FIG. 1, according to some embodiments.

FIG. 4 is a perspective view of a platform assembly of the lift device of FIG. 1, according to some embodiments.

FIG. 5 is a perspective view of the lift device of FIG. 1 including an obstacle detection system, according to some embodiments.

FIG. 6 is a perspective view of the lift device of FIG. 5, according to some embodiments.

FIG. 7A is a front view of a platform of the lift device of FIG. 5, according to some embodiments.

FIG. 7B is a back view of the platform of FIG. 7A, according to some embodiments.

FIG. 7C is a perspective view of the platform of FIG. 7A with a field of view based on sensors, according to some embodiments.

FIG. 7D is a top view of the platform of FIG. 7A with a field of view based on sensors, according to some embodiments.

FIG. 7E is a top view of the platform of FIG. 7A with sensors detecting an obstacle, according to some embodiments.

FIG. 8A is a bottom view of the platform of the lift device of FIG. 5, according to some embodiments.

FIG. 8B is a bottom view of the platform of FIG. 8A with a field of view created by sensors, according to some embodiments.

FIG. 9A is a side view of the platform of the lift device of FIG. 5, according to some embodiments.

FIG. 9B is a side view of the platform of FIG. 9A with a field of view created by sensors, according to some embodiments.

FIG. 10A is a rear view of the platform of the lift device of FIG. 5, according to some embodiments.

FIG. 10B is a perspective view of the platform of the lift device of FIG. 5 with a field of view created by sensors, according to some embodiments.

FIG. 10C is a perspective view of the platform of the lift device of FIG. 5 with an operator wearing a sensing device, according to some embodiments.

FIG. 11A is a top view of the platform of the lift device of FIG. 5 with adjustable sensors, according to some embodiments.

FIG. 11B is a top view of the platform of the lift device of FIG. 5 with adjustable sensors, according to some embodiments.

FIG. 11C is a top view of the platform of the lift device of FIG. 5 with adjustable sensors, according to some embodiments.

FIG. 12 is a perspective view of the lift device of FIG. 5 with a field of view created by sensors, according to some embodiments.

FIG. 13 is a side view of the lift device of FIG. 5 with a sensor, according to some embodiments.

FIG. 14 is a top view of the platform of the lift device of FIG. 5 with sensors monitoring a region of interest, according to some embodiments.

FIG. 15 is a side view of a jib of the lift device of FIG. 5 with sensors, according to some embodiments.

FIG. 16A is a side view of a lift assembly of the lift device of FIG. 5 with sensors, according to some embodiments.

FIG. 16B is a side view of a lift arm of the lift assembly of FIG. 16A, according to some embodiments.

FIG. 16C is a side view of a field of vision created by sensors on the lift arm of FIG. 16B, according to some embodiments.

FIG. 17 is a side view of a field of vision created by sensors of the lift device of FIG. 5, according to some embodiments.

FIG. 18 is a perspective view of a sensor coupled by a bracket to the platform of the lift device of FIG. 5, according to some embodiments.

FIG. 19 is a block diagram of an obstacle detection system of the lift device of FIG. 5, according to some embodiments.

FIG. 20A is a front view of a lift device approaching an obstacle, according to some embodiments.

FIG. 20B is a front view of a lift device approaching an obstacle, according to some embodiments.

FIG. 20C is a front view of a lift device approaching an obstacle, according to some embodiments.

FIG. 20D is a front view of a lift device approaching an obstacle, according to some embodiments.

FIG. 21 is a flow diagram of a method for obstacle detection and path selection using the obstacle detection system of FIG. 19, according to some embodiments.

FIG. 22 is a block diagram of an obstacle detection system of the lift device of FIG. 5, according to some embodiments.

FIG. 23 is a block diagram of an obstacle detection system of the lift device of FIG. 5, according to some embodiments.

FIG. 24 is a block diagram of an obstacle detection system of the lift device of FIG. 5, according to some embodiments.

FIG. 25 is a block diagram of an obstacle detection system of the lift device of FIG. 5, according to some embodiments.

### DETAILED DESCRIPTION

Before turning to the figures, which illustrate the exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overview

Referring generally to the FIGURES, a lift device includes an obstacle detection system including a plurality of sensors (e.g., LiDAR sensors, ultrasonic sensors, cameras, inertial measurement units (IMUs), infrared sensors etc.) disposed on the body of the lift device to monitor the surrounding environment of the lift device for obstacles. Based on detected obstacles the system may determine an optimal path for the lift device to autonomously move towards a destination without colliding (e.g., interacting, contacting) with the obstacle. Additionally, or alternatively, functions of the lift device may be disabled such that the operator of the lift device does not collide with obstacles. This way, instead of requiring manual monitoring of surrounding environments while operating lift devices, the system may automatically detect obstacles and respond accordingly. The lift device may include a controller that receives the user input and obtains feedback from sensors to determine specific controls of one or more controllable components to cause motion of the platform and/or the sensors according to the user input.

### Lift Device

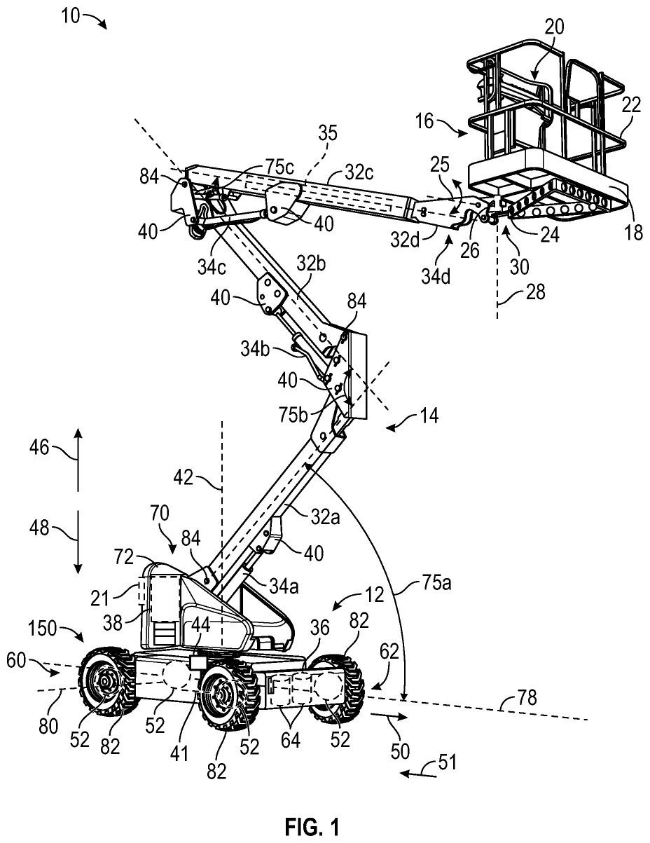

Referring to FIG. 1, a lifting apparatus, lift device, or mobile elevating work platform (MEWP) (e.g., a telehandler, an electric boom lift, a towable boom lift, a lift device, a fully electric boom lift, etc.), shown as lift device 10 includes a base assembly 12 (e.g., a base, a support assembly, a drivable support assembly, a support structure, a chassis, etc.), an implement or platform assembly 16 (e.g., a platform, a terrace, etc.), and a lift assembly 14 (e.g., a boom, a boom lift assembly, a lifting apparatus, an articulated arm, a scissor lift, etc.). The lift device 10 includes a front end (e.g., a forward-facing end, a front portion, a front, etc.), shown as front 62, and a rear end (e.g., a rearward facing end, a back portion, a back, a rear, etc. ,) shown as rear 60. The lift assembly 14 is configured to elevate the platform assembly 16 in an upward direction 46 (e.g., an upward vertical direction) relative to the base assembly 12. The lift assembly 14 is also configured to translate the platform assembly 16 in a downward direction 48 (e.g., a downward vertical direction). The lift assembly 14 is also configured to translate the platform assembly 16 in either a forward direction 50 (e.g., a forward longitudinal direction) or a rearward direction 51 (e.g., a rearward longitudinal direction). The lift assembly 14 generally facilitates performing a lifting function to raise and lower the platform assembly 16, as well as movement of the platform assembly 16 in various directions.

The base assembly 12 defines a longitudinal axis 78 and a lateral axis 80. The longitudinal axis 78 defines the forward direction 50 of lift device 10 and the rearward direction 51. The lift device 10 is configured to translate in the forward direction 50 and to translate backwards in the rearward direction 51. The base assembly 12 includes one or more wheels, tires, wheel assemblies, tractive elements, rotary elements, treads, etc., shown as tractive elements 82. The tractive elements 82 are configured to rotate to drive (e.g., propel, translate, steer, move, etc.) the lift device 10. The tractive elements 82 can each include an electric motor 52 (e.g., electric wheel motors) configured to drive the tractive elements 82 (e.g., to rotate tractive elements 82 to facilitate motion of the lift device 10). In other embodiments, the tractive elements 82 are configured to receive power (e.g., rotational mechanical energy) from prime movers or drive motors, shown as electric motors 52, or through a drivetrain (e.g., a combination of any number and configuration of a shaft, an axle, a gear reduction, a gear train, a transmission, etc.). In some embodiments, one or more tractive elements 82 are driven by a drive motor, shown as prime mover 41 (e.g., electric motor, internal combustion engine, etc.), through a transmission. In some embodiments, a hydraulic system (e.g., one or more pumps, hydraulic motors, conduits, valves, etc.) transfers power (e.g., mechanical energy) from one or more electric motors 52 and/or the prime mover 41 to the tractive elements 82. The tractive elements 82 and electric motors 52 (or prime mover 41) can facilitate a driving and/or steering function of the lift device 10. In some embodiments, the electric motors 52 are optional, and the tractive elements 82 are powered or driven by an internal combustion engine.

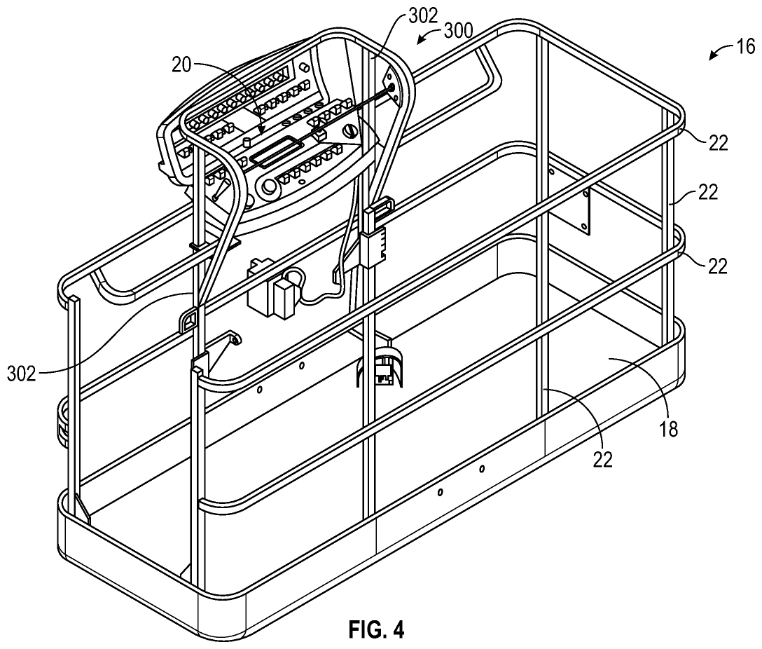

With additional reference to FIG. 4, the platform assembly 16 is shown in further detail. The platform assembly 16 is configured to provide a work area for an operator of the lift device 10 to stand/rest upon. The platform assembly 16 can be pivotally coupled to an upper end of the lift assembly 14. The lift device 10 is configured to facilitate the operator accessing various elevated areas (e.g., lights, platforms, the sides of buildings, building scaffolding, trees, power lines, etc.). The lift device 10 may use various electrically-powered motors and electrically-powered linear actuators or hydraulic cylinders to facilitate elevation and/or horizontal movement (e.g., lateral movement, longitudinal movement) of the platform assembly 16 (e.g., relative to the base assembly 12, or to a ground surface that the base assembly 12 rests upon). In some embodiments, the lift device 10 uses internal combustion engines, hydraulics, a hydraulic system, pneumatic cylinders, etc. In other embodiments, the lift device 14 includes a different type of implement in place of the platform assembly 16 (e.g., a pair of lift forks, a saw, a grapple, a bucket, etc.).

The platform assembly 16 includes a base member, a base portion, a platform, a standing surface, a shelf, a work platform, a floor, a deck, etc., shown as a deck 18. The deck 18 provides a space (e.g., a floor surface or support surface) for a worker or operator to stand upon (e.g., configured to support the worker) as the platform assembly 16 is raised and lowered.

The platform assembly 16 includes a railing assembly including various members, beams, bars, guard rails, rails, railings, etc., shown as rails 22. The rails 22 extend along substantially an entire perimeter of the deck 18. The rails 22 provide one or more members for the operator of the lift device 10 to grasp while using the lift device 10 (e.g., to grasp while operating the lift device 10 to elevate the platform assembly 16). The rails 22 can include members that are substantially horizontal to the deck 18. The rails 22 can also include vertical structural members 23 that couple with the substantially horizontal members. The vertical structural members 23 can extend upwards from the deck 18.

The platform assembly 16 can include a human machine interface (HMI) (e.g., a user interface, an operator interface, etc.), shown as the user interface 20. The user interface 20 is configured to receive user inputs from the operator at or upon the platform assembly 16 to facilitate operation of the lift device 10. The user interface 20 can include any number of buttons, levers, switches, keys, etc., or any other user input device configured to receive a user input to operate the lift device 10. The user interface 20 may also provide information to the user (e.g., through one or more displays, lights, speakers, haptic feedback devices, etc.). The user interface 20 can be supported by one or more of the rails 22.

Referring to FIG. 1, the platform assembly 16 includes a chassis or frame 24 (e.g., structural members, support beams, a body, a structure, etc.) that extends at least partially below the deck 18. The frame 24 can be integrally formed with the deck 18. The frame 24 is configured to provide structural support for the deck 18 of the platform assembly 16. The frame 24 can include any number of structural members (e.g., beams, bars, I-beams, etc.) to support the deck 18. The frame 24 couples the platform assembly 16 with the lift assembly 14. The frame 24 may be rotatably or pivotally coupled with the lift assembly 14 to facilitate rotation of the platform assembly 16 about an axis 28 (e.g., a vertical axis). The frame 24 can also rotatably/pivotally couple with the lift assembly 14 such that the frame 24 and the platform assembly 16 can pivot about an axis 25 (e.g., a horizontal axis).

As shown, the lift assembly 14 is configured as a boom assembly including one or more beams, articulated arms, bars, booms, arms, support members, boom sections, cantilever beams, etc., shown as lift arms 32a, 32b, and 32c. The lift arms are hingedly or rotatably coupled with each other at their ends. The lift arms can be hingedly or rotatably coupled to facilitate articulation of the lift assembly 14 and raising/lowering and/or horizontal movement of the platform assembly 16. The lift device 10 includes a base or lower lift arm 32a, a central or medial lift arm 32b, and a distal or upper lift arm 32c. The lower lift arm 32a is configured to hingedly or rotatably couple at one end with the base assembly 12 to facilitate lifting (e.g., elevation) of the platform assembly 16. The lower lift arm 32a is configured to hingedly or rotatably couple at an opposite end with the medial lift arm 32b. Likewise, the medial lift arm 32b is configured to hingedly or rotatably couple with the upper lift arm 32c. The upper lift arm 32c can be configured to hingedly interface/couple and/or telescope with an intermediate lift arm 32d. The upper lift arm 32c can be referred to as “the jib” of the lift device 10. The intermediate lift arm 32d may extend into an inner volume of the upper lift arm 32c and extend and/or retract. The intermediate lift arm 32d can be configured to couple (e.g., rotatably, hingedly, etc.), with the platform assembly 16 to facilitate levelling of the platform assembly 16. In other embodiments, the lift device 10 includes a different type of lift assembly 14 (e.g., a telescoping boom assembly, a scissor assembly, a vertical mast, etc.).

The lift arms 32 are driven to hinge or rotate relative to each other by actuators 34a, 34b, 34c, and 34d (e.g., electric linear actuators, linear electric arm actuators, hydraulic cylinders, etc.). The actuators 34a, 34b, 34c, and 34d can be mounted between adjacent lift arms to drive adjacent lift arms to hinge or pivot (e.g., rotate some angular amount) relative to each other about pivot points 84. The actuators 34a, 34b, 34c, and 34d can be mounted between adjacent lift arms using any of a foot bracket, a flange bracket, a clevis bracket, a trunnion bracket, etc. The actuators 34a, 34b, 34c, and 34d may be configured to extend or retract (e.g., increase in overall length, or decrease in overall length) to facilitate pivoting adjacent lift arms to pivot/hinge relative to each other, thereby articulating the lift arms and raising or lowering the platform assembly 16.

The actuators 34a, 34b, 34c, and 34d can be configured to extend (e.g., increase in length) to increase a value of an angle formed between adjacent lift arms 32. The angle can be defined between centerlines of adjacent lift arms 32 (e.g., centerlines that extend substantially through a center of the lift arms 32). For example, the actuator 34a is configured to extend/retract to increase/decrease the angle 75a defined between a centerline of the lower lift arm 32a and the longitudinal axis 78 (angle 75a can also be defined between the centerline of the lower lift arm 32a and a plane defined by the longitudinal axis 78 and lateral axis 80) and facilitate lifting of the platform assembly 16 (e.g., moving the platform assembly 16 at least partially along the upward direction 46). Likewise, the actuator 34b can be configured to retract to decrease the angle 75a to facilitate lowering of the platform assembly 16 (e.g., moving the platform assembly 16 at least partially along the downward direction 48). Similarly, the actuator 34b is configured to extend to increase the angle 75b defined between centerlines of the lower lift arm 32a and the medial lift arm 32b and facilitate elevating of the platform assembly 16. Similarly, the actuator 34b is configured to retract to decrease the angle 75b to facilitate lowering of the platform assembly 16. The electric actuator 34c is similarly configured to extend/retract to increase/decrease the angle 75c, respectively, to raise/lower the platform assembly 16. The actuators 34 may be hydraulic actuators, electric actuators, pneumatic actuators, etc.

The actuators 34a, 34b, 34c, and 34d can be mounted (e.g., rotatably coupled, pivotally coupled, etc.) to adjacent lift arms at mounts 40 (e.g., mounting members, mounting portions, attachment members, attachment portions, etc.). The mounts 40 can be positioned at any position along a length of each lift arm. For example, the mounts 40 can be positioned at a midpoint of each lift arm, and a lower end of each lift arm.

The intermediate lift arm 32d and the frame 24 are configured to pivotally interface/couple at a platform rotator 30 (e.g., a rotary actuator, a rotational electric actuator, a gear box, etc.). The platform rotator 30 facilitates rotation of the platform assembly 16 about the axis 28 relative to the intermediate lift arm 32d. In some embodiments, the platform rotator 30 is positioned between the frame 24 and the upper lift arm 32c and facilitates pivoting of the platform assembly 16 relative to the upper lift arm 32c. The axis 28 extends through a central pivot point of the platform rotator 30. The intermediate lift arm 32d can also be configured to articulate or bend such that a distal portion of the intermediate lift arm 32d pivots/rotates about the axis 25. The intermediate lift arm 32d can be driven to rotate/pivot about axis 25 by extension and retraction of the actuator 34d.

The intermediate lift arm 32d is also configured to extend/retract (e.g., telescope) along the upper lift arm 32c. In some embodiments, the lift assembly 14 includes a linear actuator (e.g., a hydraulic cylinder, an electric linear actuator, etc.), shown as extension actuator 35, that controls extension and retraction of the intermediate lift arm 32d relative to the upper lift arm 32c. In other embodiments, one more of the other arms of the lift assembly 14 include multiple telescoping sections that are configured to extend/retract relative to one another.

The platform assembly 16 is configured to be driven to pivot about the axis 28 (e.g., rotate about axis 28 in either a clockwise or a counter-clockwise direction) by an electric or hydraulic motor 26 (e.g., a rotary electric actuator, a stepper motor, a platform rotator, a platform electric motor, an electric platform rotator motor, etc.). The motor 26 (e.g., the pivot motor 26) can be configured to drive the frame 24 to pivot about the axis 28 relative to the upper lift arm 32c (or relative to the intermediate lift arm 32d). The motor 26 can be configured to drive a gear train to pivot the platform assembly 16 about the axis 28.

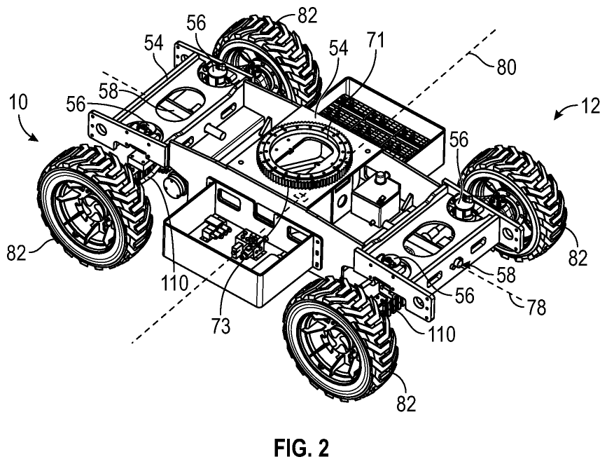

Referring to FIGS. 1 and 2, the lift assembly 14 is configured to pivotally or rotatably couple with the base assembly 12. The base assembly 12 includes a rotatable base member, a rotatable platform member, a fully electric turntable, etc., shown as a turntable 70. The lift assembly 14 is configured to rotatably/pivotally couple with the base assembly 12. The turntable 70 is rotatably coupled with a base, frame, structural support member, carriage, etc., of base assembly 12, shown as base 36. The turntable 70 is configured to rotate or pivot relative to the base 36. The turntable 70 can pivot/rotate about the central axis 42 relative to base 36, about a slew bearing 71 (e.g., the slew bearing 71 pivotally couples the turntable 70 to the base 36). The turntable 70 facilitates accessing various elevated and angularly offset locations at the platform assembly 16. The turntable 70 is configured to be driven to rotate or pivot relative to base 36 and about the slew bearing 71 by an electric motor, an electric turntable motor, an electric rotary actuator, a hydraulic motor, etc., shown as the turntable motor 44. The turntable motor 44 can be configured to drive a geared outer surface 73 of the slew bearing 71 that is rotatably coupled to the base 36 about the slew bearing 71 to rotate the turntable 70 relative to the base 36. The lower lift arm 32a is pivotally coupled with the turntable 70 (or with a turntable member 72 of the turntable 70) such that the lift assembly 14 and the platform assembly 16 rotate as the turntable 70 rotates about the central axis 42. In some embodiments, the turntable 70 is configured to rotate a complete 360 degrees about the central axis 42 relative to the base 36. In other embodiments, the turntable 70 is configured to rotate an angular amount less than 360 degrees about the central axis 42 relative to the base 36 (e.g., 270 degrees, 120 degrees, etc.).

The base assembly 12 includes one or more energy storage devices or power sources (e.g., capacitors, batteries, Lithium-Ion batteries, Nickel Cadmium batteries, fuel tanks, etc.), shown as batteries 64. The batteries 64 are configured to store energy in a form (e.g., in the form of chemical energy) that can be converted into electrical energy for the various electric motors and actuators of the lift device 10. The batteries 64 can be stored within the base 36. The lift device 10 includes a controller 38 that is configured to operate any of the motors, actuators, etc., of the lift device 10. The controller 38 can be configured to receive sensory input information from various sensors of the lift device 10, user inputs from the user interface 20 (or any other user input device such as a key-start or a push-button start), etc. The controller 38 can be configured to generate control signals for the various motors, actuators, etc., of the lift device 10 to operate any of the motors, actuators, electrically powered movers, etc., of the lift device 10. The batteries 64 are configured to power any of the motors, sensors, actuators, electric linear actuators, electrical devices, electrical movers, stepper motors, etc., of the lift device 10. The base assembly 12 can include a power circuit including any necessary transformers, resistors, transistors, thermistors, capacitors, etc., to provide appropriate power (e.g., electrical energy with appropriate current and/or appropriate voltage) to any of the motors, electric actuators, sensors, electrical devices, etc., of the lift device 10.

The batteries 64 are configured to deliver power to the motors 52 to drive the tractive elements 82. A rear set of tractive elements 82 can be configured to pivot to steer the lift device 10. In other embodiments, a front set of tractive elements 82 are configured to pivot to steer the lift device 10. In still other embodiments, both the front and the rear set of tractive elements 82 are configured to pivot (e.g., independently) to steer the lift device 10. In some examples, the base assembly 12 includes a steering system 150. The steering system 150 is configured to drive tractive elements 82 to pivot for a turn of the lift device 10. The steering system 150 can be configured to pivot the tractive elements 82 in pairs (e.g., to pivot a front pair of tractive elements 82), or can be configured to pivot tractive elements 82 independently (e.g., four-wheel steering for tight-turns).

It should be understood that while the lift device 10 as described herein is described with reference to batteries, electric motors, etc., the lift device 10 can be powered (e.g., for transportation and/or lifting the platform assembly 16) using one or more internal combustion engines, electric motors or actuators, hydraulic motors or actuators, pneumatic actuators, or any combination thereof.

In some embodiments, the base assembly 12 also includes a user interface 21 (e.g., a HMI, a user interface, a user input device, a display screen, etc.). In some embodiments, the user interface 21 is coupled to the base 36. In other embodiments, the user interface 21 is positioned on the turntable 70. The user interface 21 can be positioned on any side or surface of the base assembly 12 (e.g., on the front 62 of the base 36, on the rear 60 of the base 36, etc.).

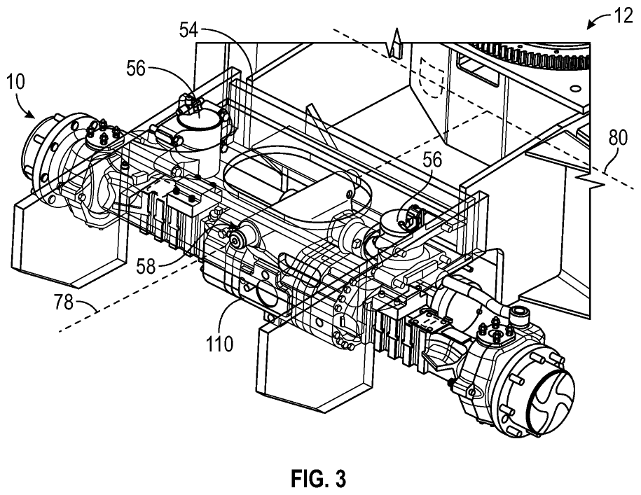

Referring now to FIGS. 2 and 3, the base assembly 12 includes a longitudinally extending frame member 54 (e.g., a rigid member, a structural support member, an axle, a base, a frame, a carriage, a chassis, etc.). The longitudinally extending frame member 54 provides structural support for the turntable 70 as well as the tractive elements 82. The longitudinally extending frame member 54 is pivotally coupled with lateral frame members 29 (e.g., axles, frame members, beams, bars, etc.) at opposite longitudinal ends of the longitudinally extending frame member 54. For example, the lateral frame members 29 may be pivotally coupled with the longitudinally extending frame member 54 at a front end and a rear end of the longitudinally extending frame member 54. The lateral frame members 29 can each be configured to pivot about a pivot joint 58 (e.g., about a longitudinal axis). The pivot joint 58 can include a pin and a receiving portion (e.g., a bore, an aperture, etc.). The pin of the pivot joint 58 is coupled to one of the lateral frame members 29 (e.g., a front lateral frame member 29 or a rear lateral frame member 29) or the longitudinally extending frame member 54 and the receiving portion is coupled to the other of the longitudinally extending frame member 54 and the lateral frame member 29. For example, the pin may be coupled with longitudinally extending frame member 54 and the receiving portion can be coupled with one of the lateral frame members 29 (e.g., integrally formed with the front lateral frame member 29).

In some embodiments, the longitudinally extending frame member 54 and the lateral frame members 29 are integrally formed or coupled (e.g., fastened, welded, riveted, etc.) to define the base 36. In still other embodiments, the base 36 is integrally formed with the longitudinally extending frame member 54 and/or the lateral frame members 29. In still other embodiments, the base 36 is coupled with the longitudinally extending frame member 54 and/or the lateral frame members 29.

The base assembly 12 includes one or more axle actuators 56 (e.g., electric linear actuators, electric axle actuators, electric levelling actuators, hydraulic cylinders, etc.). The axle actuators 56 can be linear actuators configured to receive power from the batteries 64, for example. The axle actuators 56 can be configured to extend or retract to contact a top surface of a corresponding one of the lateral frame members 29. When the axle actuators 56 extend, an end of a rod of the levelling actuators can contact the surface of lateral frame member 29 and prevent relative rotation between lateral frame member 29 and longitudinally extending frame member 54. In this way, the relative rotation/pivoting between the lateral frame member 29 and the longitudinally extending frame member 54 can be locked (e.g., to prevent rolling of the longitudinally extending frame member 54 relative to the lateral frame members 29 during operation of the lift assembly 14). The axle actuators 56 can receive power from the batteries 64, which can allow the axle actuators 56 to extend or retract. The axle actuators 56 receive control signals from controller 38.

### Obstacle Detection System

The lift device 10 can include an obstacle detection system 100 that is configured to detect one or more obstacles (e.g., objects, walls, ceilings, etc.) in an area surrounding the lift device. In some embodiments, the obstacle detection system 100 is configured to automatically operate various controllable elements of the lift assembly 14, the base assembly 12, and the platform assembly 16 responsive to a detected obstacle being within a predetermined distance of elements of the lift device 10. Some systems require the operator to visually monitor obstacles surrounding the lift device 10, and manually control the actuators 34, the extension actuator 35, the turntable 70 and/or the tractive elements 82 to avoid the obstacles. The obstacle detection system 100 can be configured to actively monitor the area surrounding the lift device 10 for obstacles, determine distances between the lift device 10 and the obstacles, warn the operator regarding detected obstacles, and determine controls (e.g., stopping, movement, path, etc.) for the turntable 70, the actuators 34, the extension actuator 35, and/or the tractive elements 82 such that the lift device 10 operates without interacting (e.g., contacting, colliding, etc.) with obstacles.

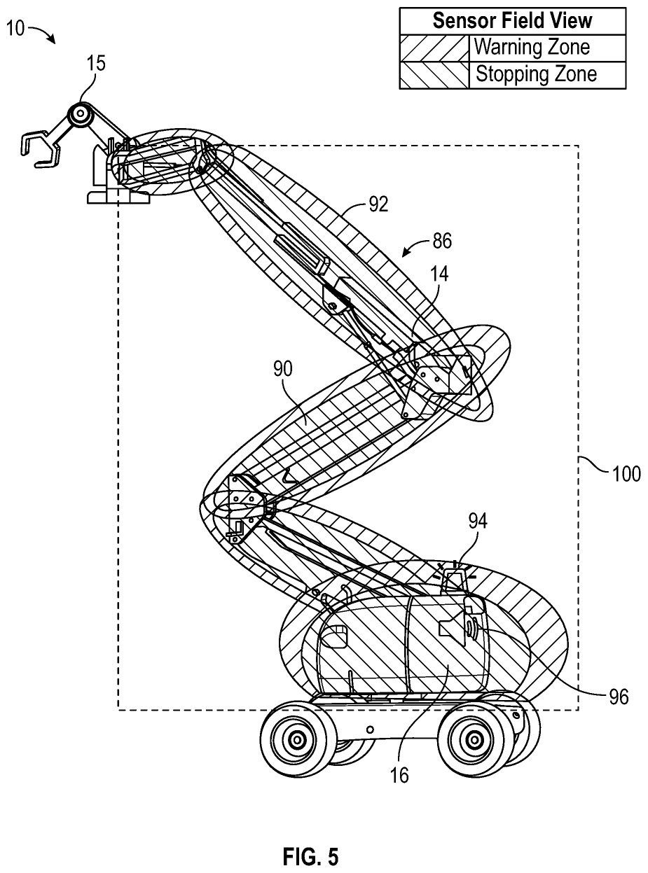

Referring to FIG. 5, the lift device 10 is shown to include a field of view 86 corresponding to the field of view of the obstacle detection system 100 (e.g., the collective fields of view of multiple sensors). In some embodiments, the lift assembly 14, the platform assembly 16, and/or the base assembly 12 includes a plurality of sensors (e.g., LiDAR sensors, ultrasonic sensors, other sensors) disposed on an external surface of the lift device 10 to detect obstacles in an area surrounding the lift device 10. The sensors may be placed in any location of the lift device 10, and the lift device 10 may include any number of sensors. The field of view 86 includes a first area, portion, zone, etc., shown as stop zone 90, a second area, portion, zone, etc., shown as warning zone 92 according to an exemplary embodiment. In some embodiments the field of view 86 includes additional zones. The field of view 86 may include an area surrounding the lift assembly 14, the platform assembly 16, the base assembly 12, and/or any other area surrounding the lift device 10.

The warning zone 92 may correspond to an outer area of the field of view 86 that is a larger distance from the lift device 10 than the stop zone 90. For example, the field of view 86 may extend from the body of the lift device 10 to an outer edge of the warning zone 92, and the stop zone 90 may extend from the body of the lift device 10 to an inner edge of the warning zone 92. In some embodiments, the width (e.g., distance from the lift device) of the warning zone 92 and the stop zone 90 may be based on each sensor of the obstacle detection system 100. For example, a first sensor of the obstacle detection system may have a first warning zone 92 and a first stop zone 90, and a second sensor of the obstacle detection system 100 may have a second warning zone 92 and a second stop zone 90. In some embodiments, the width of the warning zone 92 and the stop zone 90 may vary for different components of the lift device. For example, the width of the warning zone 92 and the stop zone 90 in the area surrounding the lift assembly 14 may be different than the width of the warning zone 92 and the stop zone 90 in the area surrounding the platform assembly 16.

When an obstacle is detected in the warning zone 92, the operator may be notified of the obstacle. In some embodiments, the notification is a visual notification. For example, the notification may be an indicator light 94 disposed on the body of the lift device 10. As another example, the notification may be a message displayed on a user device disposed on the platform assembly 16. In some embodiments, the notification is an auditory notification. For example, the notification may be an indicator sound played on a speaker 96 disposed on the lift device 10. The notification may include (e.g., indicate) information regarding the detected obstacle. For example, the notification may indicate a distance between the lift device 10 and the obstacle (e.g., by varying the pattern or frequency of an emitted sound proportional to the distance). As another example, the notification may indicate an area of the lift device 10 where the obstacle was detected.

When an obstacle is detected in the stop zone 90, the actuators 34, the extension actuator 35, the prime mover 41, the motors 52, and/or other elements of the lift device 10 may be limited or disabled (e.g., restricted, disconnected, etc.) such that movement the lift device 10 is limited. In some embodiments, the lift device 10 is limited or prevented from moving in all directions. In some embodiments, the lift device 10 is limited or prevented from moving toward the obstacle but permitted to move away from the obstacle. In some embodiments, the operator may receive instructions for moving the lift device away from the obstacle before the elements are re-enabled for operator use. For example, if the obstacle is detected near the lift assembly 14, the operator may receive a notification including instructions for moving the lift assembly 14 away from the obstacle. In some embodiments, the lift device 10 may automatically (e.g., autonomously) operate to move away from the obstacle. For example, the lift device 10 may automatically operate the motors 52 to move the lift device 10 away from the obstacle.

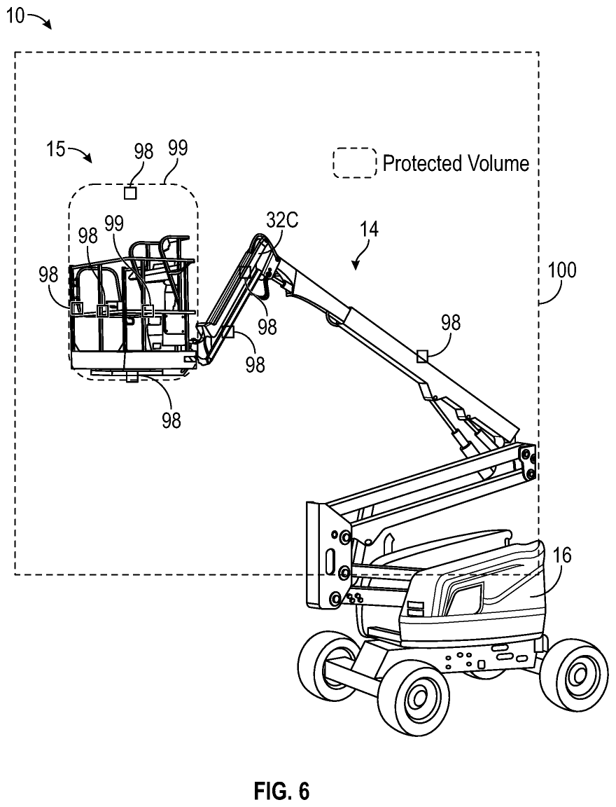

Referring to FIG. 6, the obstacle detection system 100 may include a plurality of sensors 98 (e.g. LiDAR sensors, ultrasonic sensors, infrared sensors, cameras, imaging devices, inertial measurement units (IMU), etc.) disposed in numerous locations on the lift device 10. The sensors 98 may all be the same type of sensor, or may include a plurality of different sensor types. As shown, the obstacle detection system may have sensors 98 disposed on the platform assembly 16 and the lift assembly 14. For example, there may be a first group of sensors 98 placed in an area above the platform assembly 16, a second group of sensors 98 placed on a bottom portion (e.g., under side) of the platform assembly 16, a third group of sensors 98 placed on a left side and a right side of the platform assembly 16, a fourth group of sensors 98 placed on a front portion of the platform assembly 16, a fifth group of sensors placed on a back (e.g., rear) portion of the platform assembly 16, a sixth group of sensors placed on a first portion of the jib 32c, a seventh group of sensors placed on a second portion of the jib 32c, and an eighth group of sensors placed on the lift arm 32a and/or the lift arm 32b. In other embodiments, there may be sensors disposed on other elements of the lift device 10, such as the base assembly 12.

As shown in FIG. 6, the platform assembly 16 may include a protected volume 99. The protected volume 99 may be an area including the platform assembly 16 and an area above the platform assembly. The area above the platform assembly 16 may correspond to a height of an operator of the lift device 10 and/or the height of a load placed in the platform assembly 16. The sensors 98 may be placed (e.g., positioned) such that the entire protected volume 99 is in the field of view (e.g., field of view 86) of the sensors 98.

In some embodiments, sensors 98 include a camera (e.g., on the bottom of the platform 16 in FIG. 6) and an IMU (e.g., on a side of the platform 16 in FIG. 6) each coupled to the platform 16. The camera may capture image data describing a surrounding environment of the platform 16 within a field of view of the camera. The IMU may include gyroscopic sensors, accelerometers, and/or other sensors to determine a pose (e.g., position and orientation) of the IMU in space. If the IMU and the camera are each fixedly coupled to the platform 16, the relative position and orientation of the IMU and the field of view of the camera may be predetermined. Processing circuitry (e.g., the controller 38) may analyze the image data from the camera to determine the size, shape, and position of obstacles within the field of view of the camera. Based on sensor data from the IMU, the processing circuitry may then determine the positions of the obstacles in space. In this way, the processing circuitry may identify obstacles that should be avoided and determine their positions in space and relative to the lift device 10.

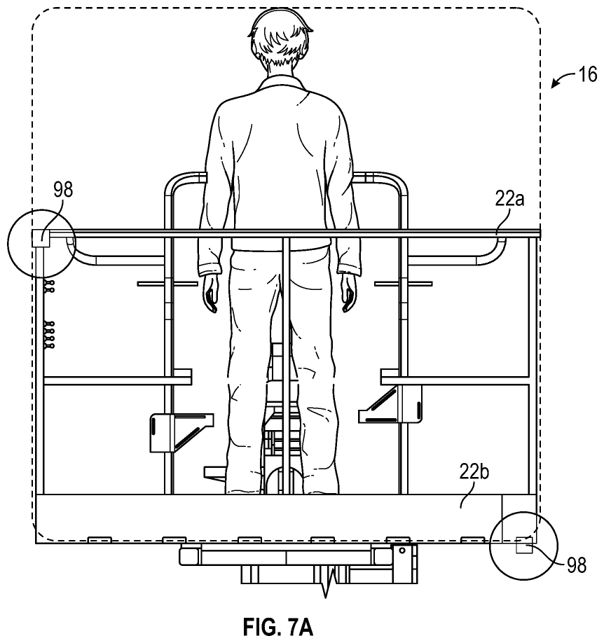

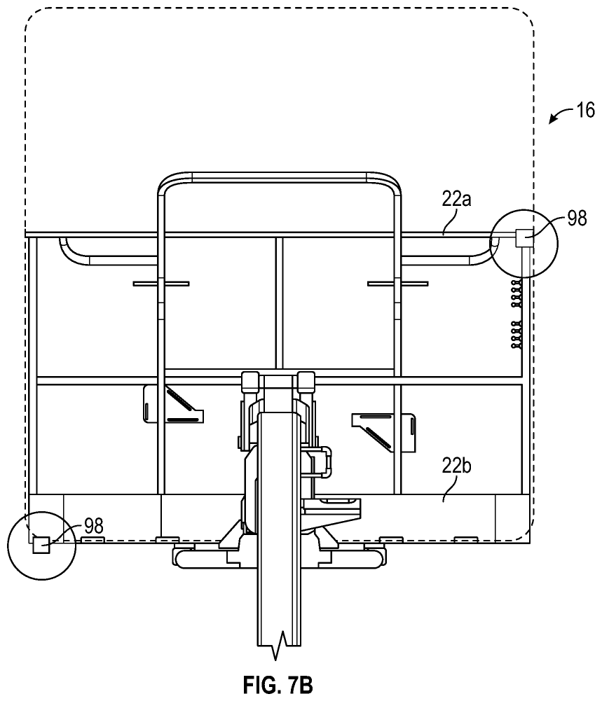

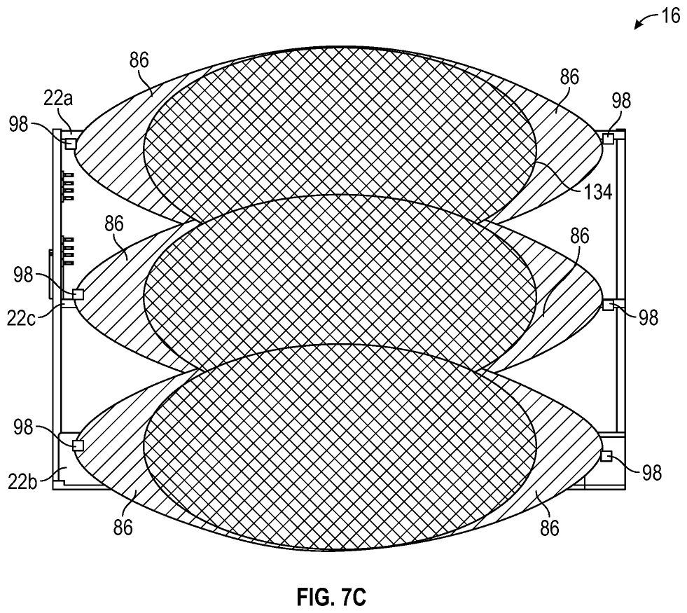

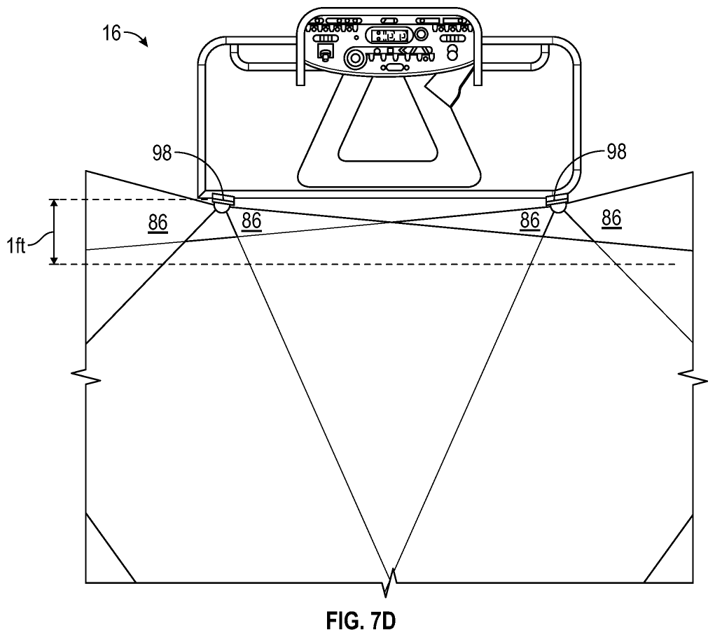

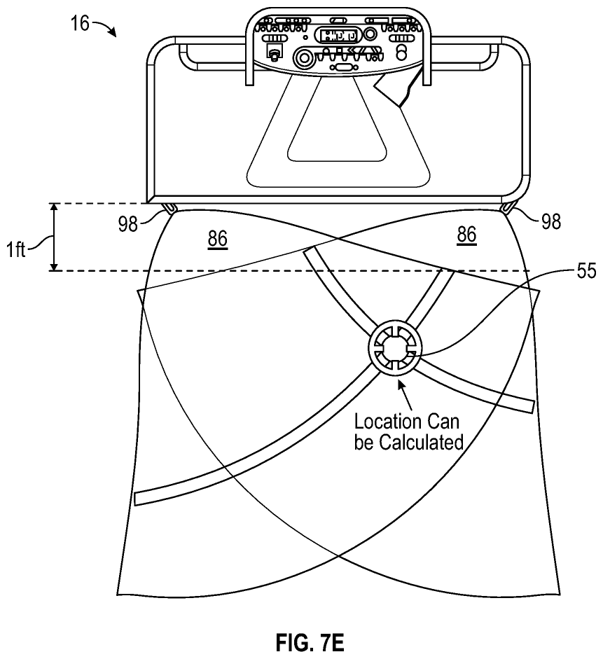

Referring to FIG. 7A, there may be a plurality of sensors 98 disposed on a front surface of the platform assembly 16. As shown, there may be a first sensor 98 disposed on a top rail 22a of the platform assembly 16, and a second sensor 98 disposed on a bottom rail 22b of the platform assembly 16. The first sensor 98 and the second sensor 98 may be placed such that they are positioned in opposite corners of the front portion of the platform assembly 16. For example, the first sensor 98 may be positioned on the leftmost portion of the top rail 22a, and the second sensor 98 may be positioned on the rightmost portion of the bottom rail 22b. In other embodiments, there may be additional sensors 98 positioned on the front surface of the platform assembly 16, and/or the sensor 98 may be positioned in different locations of the front surface of the platform assembly 16.

Referring to FIG. 7B, there may be a plurality of sensors 98 disposed on a rear surface of the platform assembly 16. As shown, there may be a first sensor 98 disposed on a top rail 22a of the platform assembly 16, and a second sensor 98 disposed on a bottom rail 22b of the platform assembly 16. The first sensor 98 and the second sensor 98 may be placed such that they are positioned in opposite corners of the rear portion of the platform assembly 16. For example, the first sensor 98 may be positioned on the rightmost portion of the top rail 22a, and the second sensor 98 may be positioned on the leftmost portion of the bottom rail 22b. In other embodiments, there may be additional sensors 98 positioned on the rear surface of the platform assembly 16, and/or the sensor 98 may be positioned in different locations of the rear surface of the platform assembly 16.

Referring to FIG. 7C-7E, the sensors 98 positioned on the front/rear surface of the platform assembly 16 may create a field of view 86 (e.g., for the obstacle detection system 100). In some embodiments, the field of view 86 is based on the location of the sensors 98 on the front/rear surface of the platform assembly 16. In some embodiments, the field of view 86 is based on features (e.g., limitations, capabilities) of the sensors 98.

Referring to FIG. 7C, each sensor 98 may have a field of view 86 that extends from the sensor 98 substantially horizontally across the front/rear surface of the platform assembly 16. According to the exemplary embodiment shown, the front/rear surface of the platform assembly 16 may have six sensors: two sensors 98 positioned on the top rail 22a, two sensors 98 positioned on a middle rail 22c, and two sensors 98 positioned on the bottom rail 22b. For example, a sensor 98 positioned on a left side of the top rail 22a may have a field of view that extends horizontally from the sensor 98 to an end point 134 on the top rail 22a to the right of the sensor 98. The width of the field of view 86 (e.g., vertical distance) and/or the distance from the sensor to the end point 134 may be based on limitations of the sensors 98. In some embodiments, the field of views 86 of the sensors 98 may overlap with other field of views 86 of the sensors 98. For example, an end point 134 of a first sensor 98 may be within a field of view 86 of a second sensor 98. In some embodiments, the number of sensors 98 disposed on the front/rear surface of the platform assembly corresponds to the field of views 86 of the sensors 98. For example, the number of sensors 98 may be selected such that the entire front/rear portion of the platform assembly is within at least one field of view 86.

Referring to FIG. 7D, each sensor 98 may have a field of view 86 that extends from the side portions of the sensor 98. For example, each sensor may have two field of views 86: a first field of view 86 extending from a left side of the sensor 98, and a second field of view 86 extending from a right side of the sensor 98. Each field of view 86 may extend forward a certain distance from the front/rear portion of the platform assembly 16. In some embodiments, the sensors 98 are angled (e.g., tilted, positioned on a curved surface, etc.) such that the field of views 86 are not parallel with the platform assembly 16, thereby increasing an amount of overlap between field of views 86 of different sensors 98.

Referring to FIG. 7E, the distance between the platform assembly and an obstacle 55 can be detected (e.g., determined, calculated, triangulated, indicated) based on positions of the obstacle within the field of view 86 of multiple sensors 98. Since the distance between each sensor 98 and the obstacle 55 may be different from the distance between the platform assembly 16 and the obstacle 55, overlap between field of views 86 can be used to estimate (e.g., determine, calculate) the distance between the platform assembly 16 and the obstacle 55. For example, if the obstacle 55 is a first distance from a first sensor 98 and a second distance from a second sensor, a shortest distance between the obstacle 55 and the platform assembly 16 may be triangulated (e.g., calculated). In other embodiments the sensors 98 (e.g., LiDAR sensors) provides 3D point cloud data, which may allow for determining the location of the obstacle without triangulation. Accordingly, the sensors 98 may indicate the position of the obstacle 55 relative to the platform assembly 16 or any other part of the lift device 10.

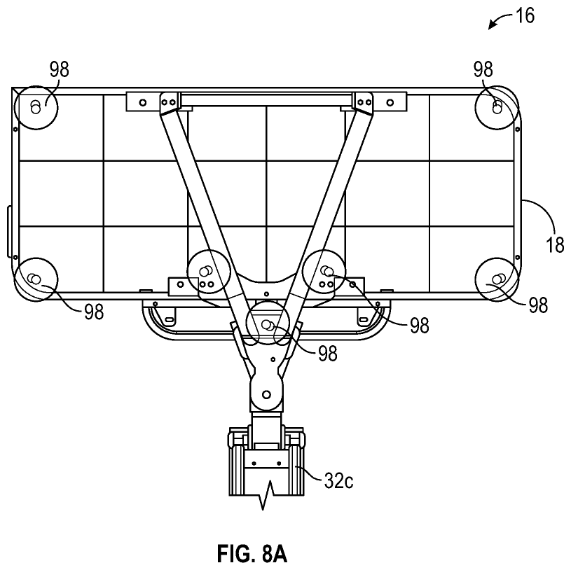

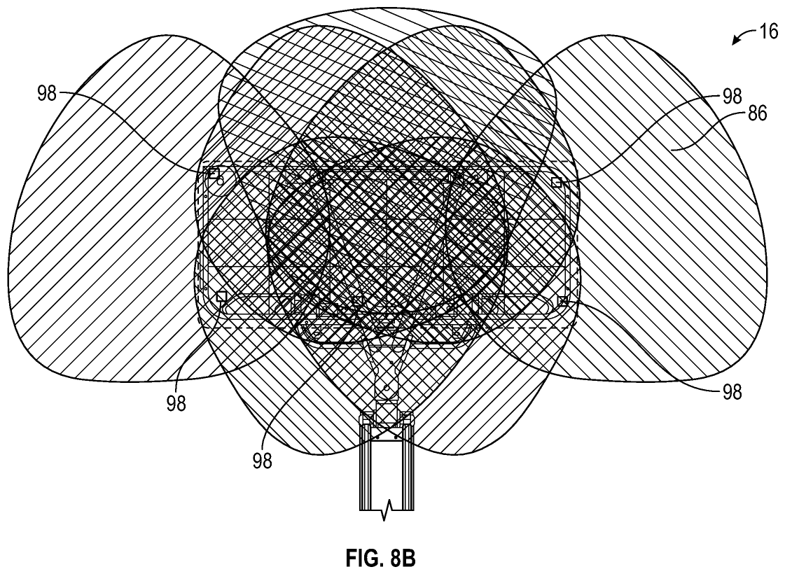

Referring to FIG. 8A, there may be a plurality of sensors 98 disposed on a bottom surface of the platform assembly 16 (e.g., bottom surface of the deck 18). As shown, there may be a sensor 98 disposed in each corner of the bottom surface of the platform assembly 16 and/or sensors 98 disposed near a connection point between the platform assembly 16 and the jib 32c. The sensors 98 may be placed in any configuration (e.g., pattern) such that the entire bottom surface of the platform assembly 16 and a bottom portion of the jib are within a field of view of the sensors 98. The sensors 98 may be LiDAR sensors, ultrasonic sensors, or any other type of sensor.

Referring to FIG. 8B, the field of view 86 of the plurality of sensors 98 positioned on the bottom of the platform assembly 16 may cover (e.g., reach, view, etc.) the entire bottom portion of the platform assembly 16. In FIG. 8B, different hatching may represent the fields of view of different sensors 98. In some embodiments, the field of view 86 extends (e.g., horizontally, vertically) past one or more edges of the bottom of the platform assembly 16. This may allow for the detection of obstacles that are located both directly beneath the platform assembly 16, as well as below and adjacent to (e.g., diagonally displaced from) the platform assembly 16. The field of view 86 may extend a distance beneath the platform assembly 16. The distance beneath the platform assembly 16 may correspond to limitations (e.g., capability) of the sensors 98 and/or be a predetermined distance. For example, the field of view 86 may extend a distance of one foot beneath the platform assembly 16. As another example, the field of view may extend a different distance beneath the platform assembly 16.

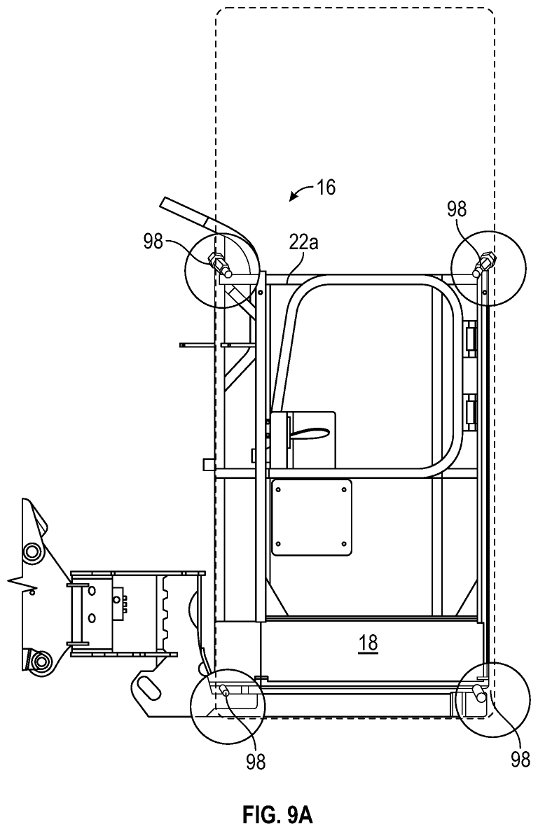

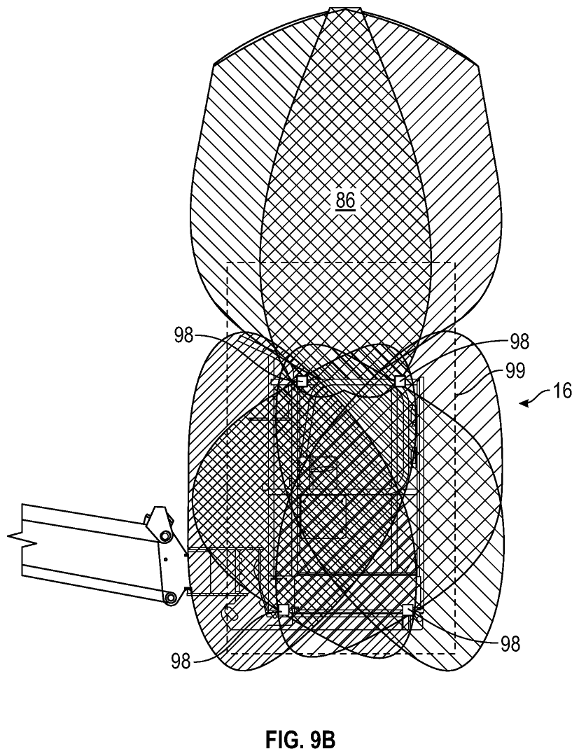

Referring to FIG. 9A, there may be a plurality of sensors 98 disposed on the left and/or right side surfaces of the platform assembly 16. The sensors 98 may be arranged to detect obstacles around (e.g., near) the sides of the platform assembly and/or the protected volume 99. As shown, there may be a sensor 98 disposed in each corner of the side surface of the platform. For example, there may be two groups of sensors 98 on the top rail 22a of the side surface, and two groups of sensors 98 on the side surface of the deck 18. In other embodiments, the sensors 98 may be placed in any configuration (e.g., pattern, arrangement, etc.) such that the entire side surface of the platform assembly 16 and/or the protected volume 99 are within a field of view of the sensors 98. The groups of sensors 98 may have any number of sensors 98. For example, the two groups of sensors 98 on the top rail 22a may each have two sensors and the two groups of sensors 98 on the side surface of the deck 18 may each have one sensor. The sensors 98 may be LiDAR sensors, ultrasonic sensors, or any other type of sensor.

Referring to FIG. 9B, the field of view 86 of the plurality of sensors 98 positioned on the side(s) of the platform assembly 16 may cover (e.g., reach, view, etc.) the entire side portion of the platform assembly 16 and/or the entire side portion of the protected volume 99. In some embodiments, the field of view 86 extends (e.g., horizontally, vertically) past one or more side edges of the protected volume 99. This may allow for the detection of obstacles that are located both directly adjacent to the protected volume 99, as well as above and below to the protected volume 99. The field of view 86 may extend a horizontal distance away from the protected volume 99. The distance away from the protected volume 99 may correspond to limitations (e.g., capability) of the sensors 98 and/or be a predetermined distance. For example, the field of view 86 may extend a distance of one foot away from the protected volume 99. As another example, the field of view may extend a different distance away from the protected volume.

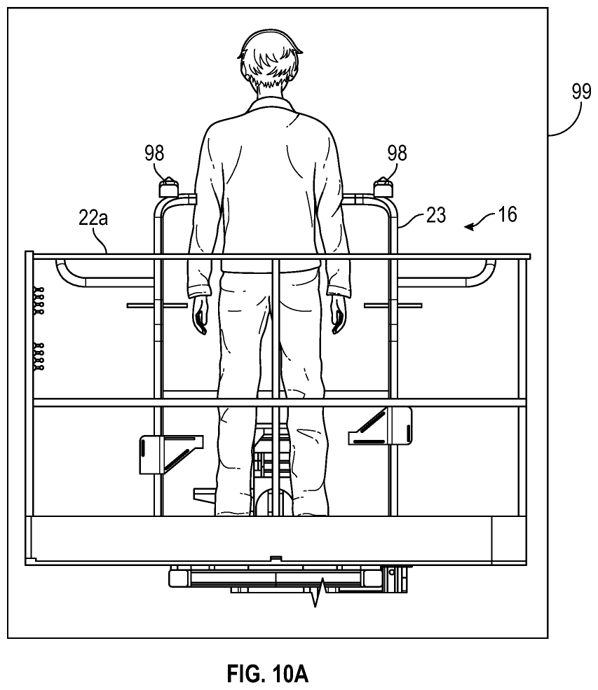

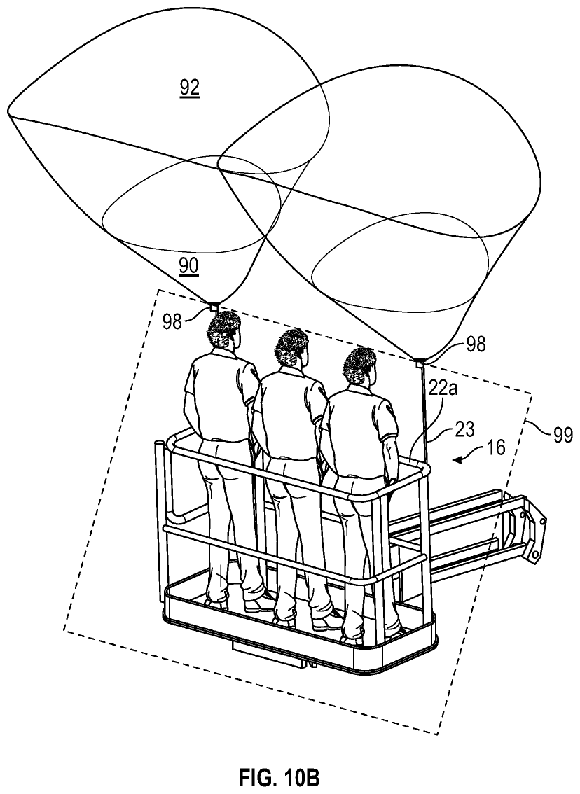

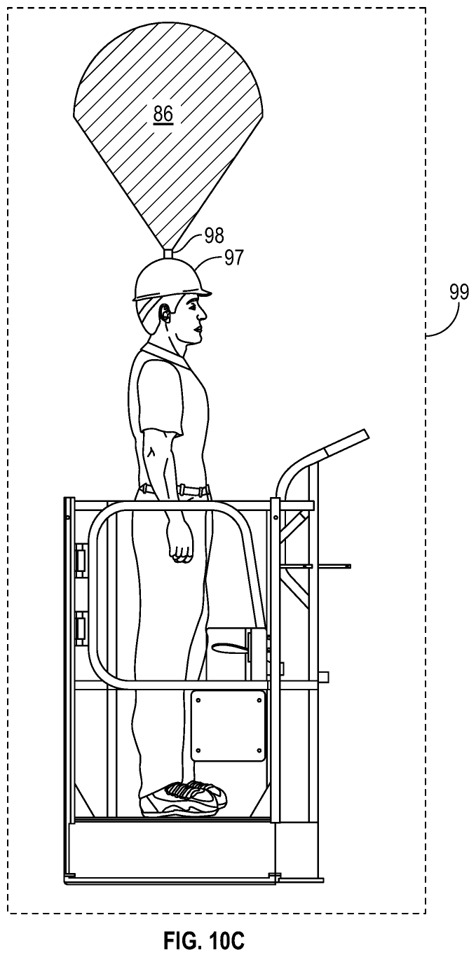

Referring to FIG. 10A-10C, the protected volume 99 may extend a height above the platform assembly 16. The height of the protected volume 99 may vary depending on a load of the platform assembly 16. For example, if the platform assembly 16 is holding the operator, the height of the protected volume 99 may correspond to the height of the operator (e.g., be a height taller than the operator). As another example, if the platform assembly 16 is holding an object, the height of the protected volume 99 may correspond to the height of the object. Since the height of the protected volume 99 may not be the same as the height of the platform assembly 16, it may be beneficial to detect (e.g., identify, sense, etc.) obstacles at a height above the platform assembly 16.

Referring to FIG. 10A, one or more sensors 98 may be placed on a top portion of the platform assembly 16. As shown, the platform assembly 16 may include one or more sensors 98 placed on a top portion of the vertical structural members 23. Additionally, or alternatively, one or more sensors 98 may be placed on the top rail 22a of the platform assembly 16. The sensors 98 may detect obstacles in an area from the top of the platform assembly 16 and extend to an area above the protected volume 99. For example, the sensors 98 may detect obstacles in an area that is one foot above the top of the protected volume 99. As another example, the sensors 98 may detect obstacles in an area that is a different distance above the top of the protected volume 99. The sensors 98 may be LiDAR sensors, ultrasonic sensors, or any other type of sensor.

Referring to FIG. 10B, the vertical structural members 23 may extend from the top rail 22a to the top of the protected volume 99. For example, a first vertical structural member 23 may be or include a first telescopic rod extending from the leftmost end of the front portion of the top rail 22a, and a second vertical structural member 23 may be or include a second telescopic rod extending from the rightmost end of the front portion of the top rail 22a. One or more sensors 98 may be disposed at the top of the vertical structural members 23. The sensors 98 may detect obstacles in an area above the protected volume 99. For example, the sensors 98 may detect obstacles in the warning zone 92 and the stop zone 90 above the protected volume 99. In some embodiments, the lengths of the vertical structural members 23 are adjustable (e.g., moveable), such that the height of the protected volume 99 can be adjusted by extending or retracting the vertical structural members 23. The sensors 98 may be LiDAR sensors, ultrasonic sensors, or any other type of sensor. This may facilitate adjusting the protected volume 99 (e.g., to accommodate operators of different heights).

Referring to FIG. 10C, since the protected volume 99 may be based on the height of the operator, it may be beneficial for obstacles to be detected in an area directly above the operator. Accordingly, one or more sensors 98 may be placed on a piece of personal protective equipment, shown as wearable device 97 (e.g., hat, helmet, head covering, etc.) of the operator. For example, a LiDAR and/or ultrasonic sensor may be placed on the top of the wearable device 97 such that when the wearable device 97 is worn by (e.g., placed on the head of) the operator, the area above the operator is in the field of view 86 of the sensor 98. The field of view 86 of the sensor may extend a predetermined distance above the operator. For example, the field of view 86 may extend to an area that is one foot above the operator. As another example, the field of view 86 may extend to an area that is a different distance above the operator.

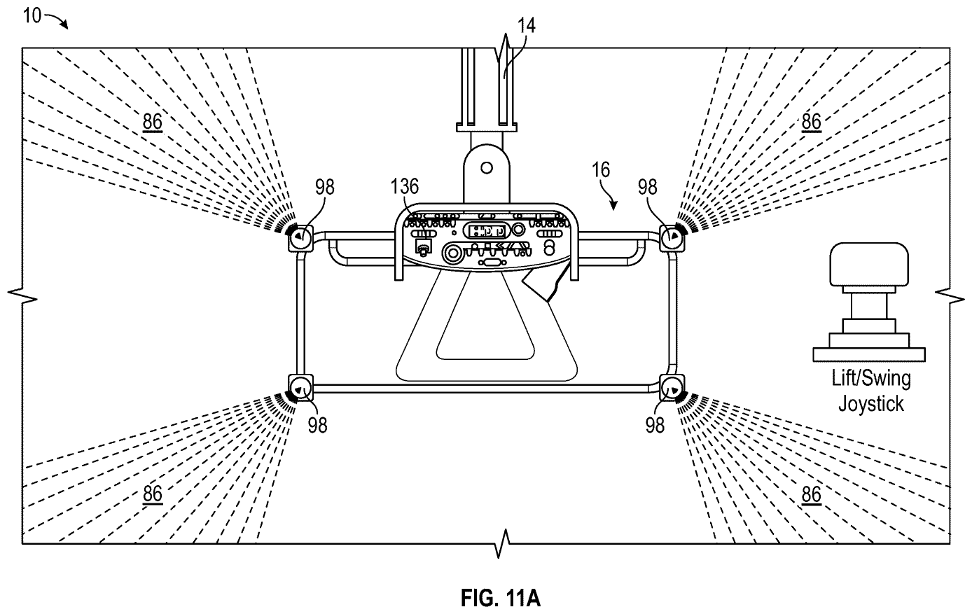

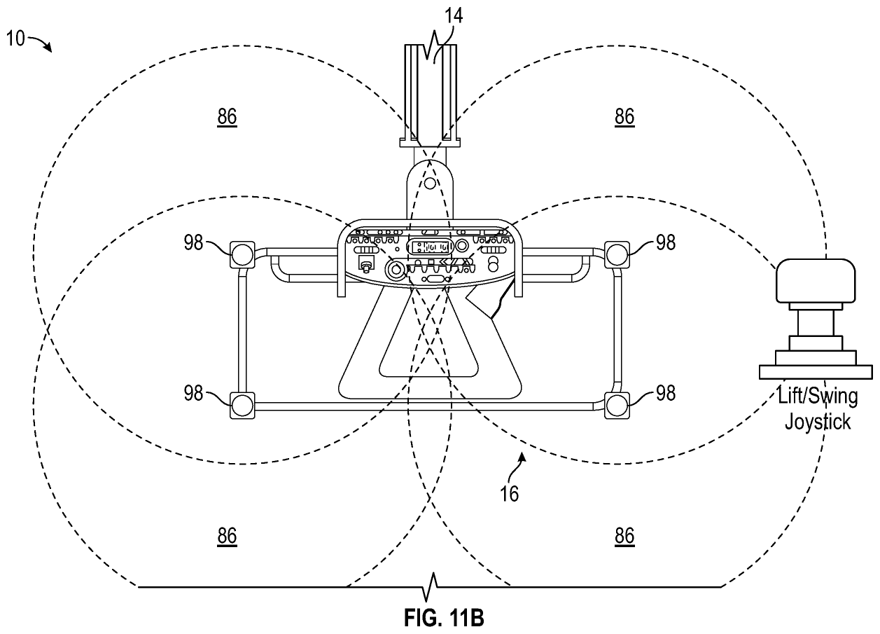

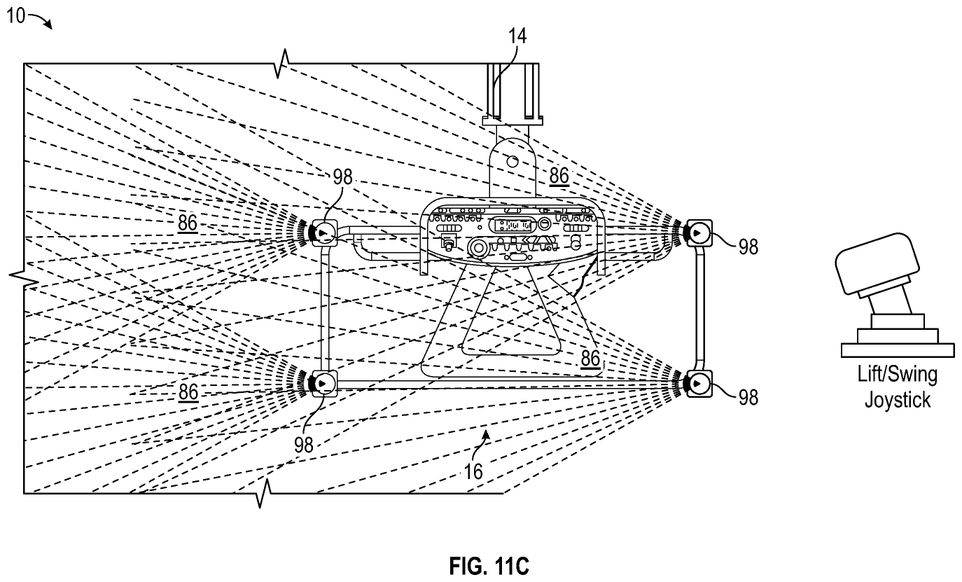

Referring to FIG. 11A-11C, the sensors 98 may be pivotably (e.g., rotatably) coupled to the platform assembly 16. For example, the sensors 98 may be adjustable to monitor different areas around the platform assembly 16 for obstacles. Each of the sensors 98 may include an actuator (e.g., an electric motor) that is configured to control movement of the sensors 98 relative to the platform assembly 16, or the sensors 98 may be manually adjustable. The actuators of the sensors 98 may be controlled by a controller or processing circuity (e.g., the controller 38) to reorient the sensors 98. The processing circuitry may control the actuators of the sensors 98 based on a direction of movement of the lift device 14. By way of example, if the platform assembly 16 is moving to the left, the actuators may orient one or more of the sensors 98 to face to the left (e.g., in the direction of motion of the platform assembly 16).

In some embodiments, the platform assembly 16 may include one or more selectable elements 136 (e.g., switches, joysticks, buttons, etc.) configured to pivot at least one sensor 98. For example, interacting with a selectable element 136 may cause a controller to operate the actuators of the sensor 98 to pivot all of the sensors 98. As another example, there may be a separate selectable element 136 to pivot each individual sensor 98. In some embodiments, there may be a single selectable element corresponding to movement of the sensors 98 and movement of the lift assembly 14. For example, the sensors 98 may pivot in a direction of movement of the lift assembly 14, such that the sensors 98 are monitoring an area of movement of the lift device 10. In one such an example, the controller 38 determines how the lift assembly 14 is moving currently or will be moving in the future and orients one or more of the sensors 98 to face the fields of view 86 in a corresponding direction. Additionally, or alternatively, the sensors 98 may be pivoted responsive to interaction with a device remote of the platform assembly 16.

Referring to FIG. 11A, the sensors 98 may be in an initial (e.g., default) position. The initial position may correspond to when the lift assembly 14 and/or lift device 10 are stationary. In the initial position, the sensors 98 may be monitoring an area extending outward from each corner of the platform assembly 16. For example, the field of view 86 of each sensor 98 may not overlap (e.g., intersect), such that a wide area can be monitored for obstacles.

Referring to FIG. 11B, the sensors 98 may be in a lifting (e.g., raising) position with the fields of view 86 generally oriented upward. The raising position may correspond to when the lift assembly 14 and/or the platform assembly 16 are being raised (e.g., elevated). When the platform assembly 16 is being raised, it may be more likely that the lift device 10 will interact with (e.g., move towards) obstacles located above the platform assembly 16 than obstacles located in other areas around the lift device 10. Accordingly, in the raising position, the one or more sensors 98 may pivot such that the sensors 98 are monitoring an area above the platform assembly 16. For example, the field of view 86 of the sensors 98 may substantially cover an entire area above the platform assembly 16, such that obstacles above the platform assembly 16 can be detected as the platform assembly 16 is being raised.

Referring to FIG. 11C, the sensors 98 may be in a translating (e.g., moving) position. The translating position may correspond to when the lift assembly 14 is extending or retracting horizontally, or the lift device 10 is moving across a work surface, thereby translating the platform assembly 16. When the platform assembly 16 is translating (e.g., in a horizontal direction), it may be more likely that the lift device 10 will interact with (e.g., move towards) obstacles in the direction of motion rather than obstacles located in other areas around the lift device 10. Accordingly, in the translating position, the one or more sensors 98 may pivot such that the sensors 98 are monitoring an area in the direction of motion of the platform assembly 16. For example, the field of view 86 of the sensors 98 may substantially cover a front portion, a rear portion, or a side portion of the platform assembly, such that obstacles in the direction of motion (e.g., travel) can be more effectively detected.

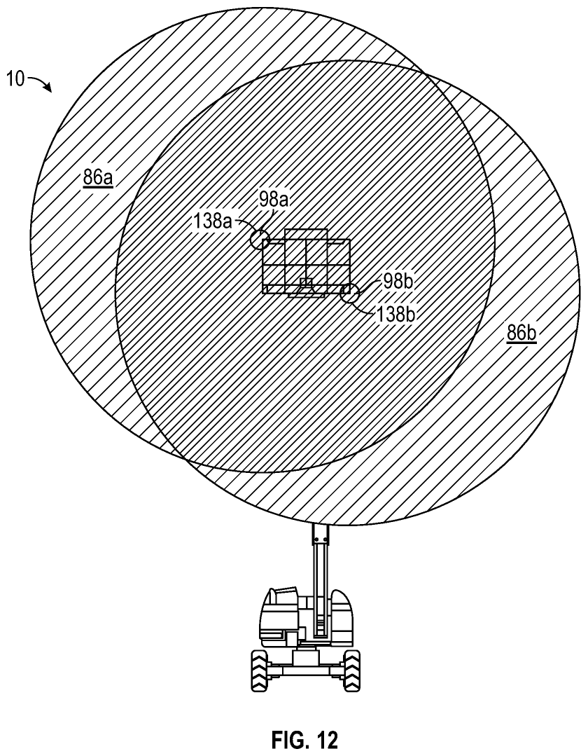

Referring to FIG. 12, each sensor 98 may have one or more locations within its field of view 86 where obstacles cannot be detected, shown as blind spots 138. To mitigate the impacts of an inability for a sensor to detect obstacles in its blind spots 138a and 138b, the field of view 86 of each sensor 98 may be positioned to include the blind spots of a different sensor 98. For example, a first sensor 98a and a second sensor 98b may be positioned on the platform assembly such that a blind spot 138a of the first sensor 98a is covered (e.g., monitored) by a second field of view 86b the second sensor 98b, and a blind spot 138b of the second sensor 98b is covered by a first field of view 86a (e.g., monitored) by the first sensor 98a.

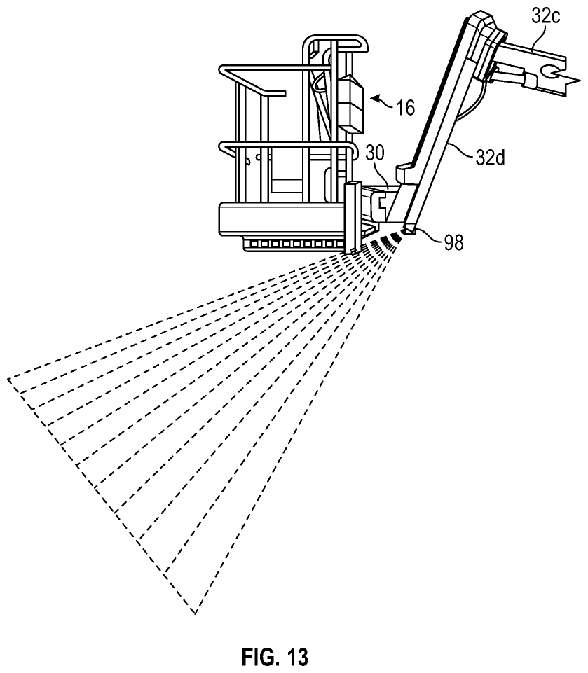

Referring to FIG. 13, one or more sensors 98 may be placed on the intermediate arm 32d to monitor an area below the platform assembly 16. Since the platform rotator 30 pivots (e.g., adjusts the angle of) the intermediate arm 32d and the platform assembly 16 relative to the jib 32c, a sensor 98 may not always be monitoring the area directly beneath the platform assembly 16 (e.g., field of view of the sensor 98 moves relative to the platform assembly 16 as the lift assembly 14 moves). For example, if a sensor 98 is directly coupled to the bottom of the platform assembly 16, and the platform assembly 16 is at an angle that is not parallel to the work surface (e.g., ground), the sensor 98 may not be monitoring an area below the platform assembly 16, but rather an area in front of or behind the platform assembly 16. Placing a sensor on the intermediate arm 32d ensures that there is a sensor that has the same angle (e.g., relative to the work surface) as the platform assembly 16. Accordingly, the area directly beneath the platform assembly 16 may be monitored at a plurality of different angles of the platform assembly 16.

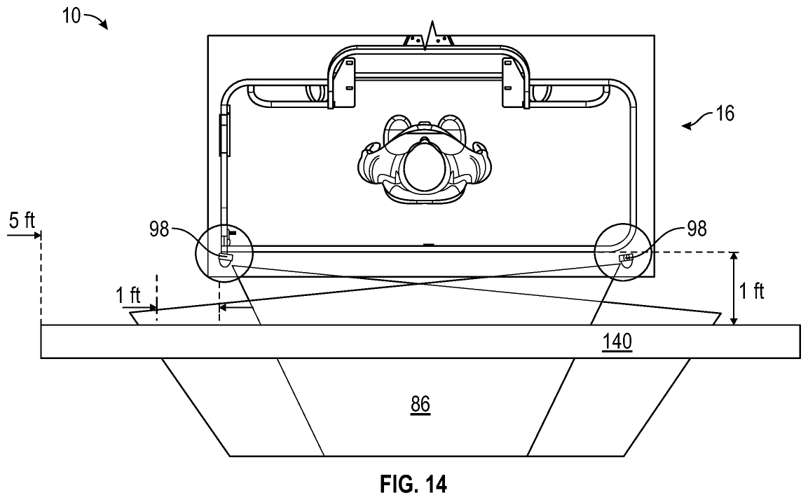

According to the exemplary embodiment shown in FIG. 14, the sensors 98 may be arranged (e.g., positioned, disposed, arranged, etc.) on the platform assembly 16 such that a specific region of interest 140 of the surrounding area of the lift device 10 may be monitored for obstacles. For example, the region of interest 140 may be an area that is approximately one foot away from the front portion of the platform assembly 16. In some embodiments, due to limitations of the sensors 98, the sensors 98 may be unable to monitor the entire region of interest 140. In these cases, the sensors 98 may be positioned such that a maximum portion of the region of interest 140 is within the field of view 86 of the sensors 98. For example, an angle of the sensors 98 relative to the platform assembly 16 may be optimized (e.g., selected) to maximize the portion of the region of interest 140 that is within the field of view 86. As another example, an angle of the sensors 98 relative to the platform assembly 16 may be optimized (e.g., selected to maximize the overlap of the field of view 86 of each sensor within the region of interest 140.

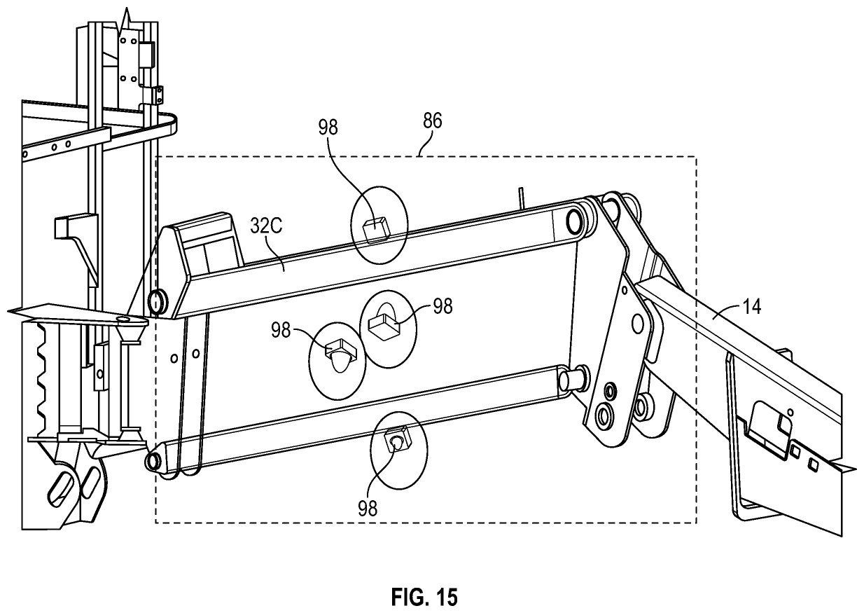

Referring to FIG. 15, one or more sensors 98 may be placed (e.g., positioned, disposed, arranged) on the jib 32c to monitor an area surrounding the jib 32c and other portions of the lift assembly 14. Various implementations may have varying numbers of sensors 98 on the jib 32c in a plurality of different locations and may have a plurality of different types of sensors (e.g., LiDAR, ultrasonic, infrared, cameras, etc.). For example, the jib 32c may have four LiDAR sensors 98: one sensor 98 on a top portion of the jib 32c, one sensor 98 on a bottom portion of the jib, and one sensor 98 on each side portion of the jib 32c. Each sensor 98 may have an individual field of view 86 that combine to substantially cover (e.g., monitor) the jib 32c, and optionally other portions of the lift assembly 14 (e.g., arm 32a, arm 32b, etc.).

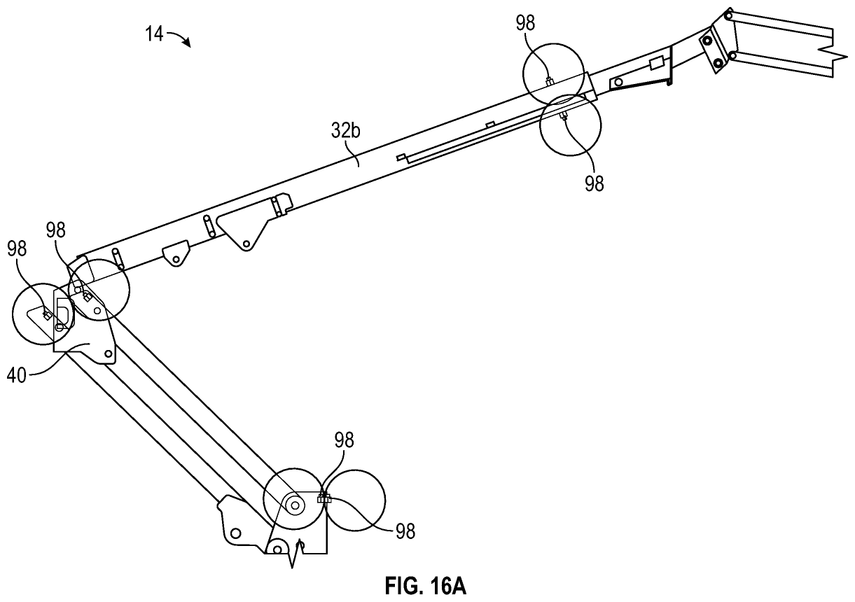

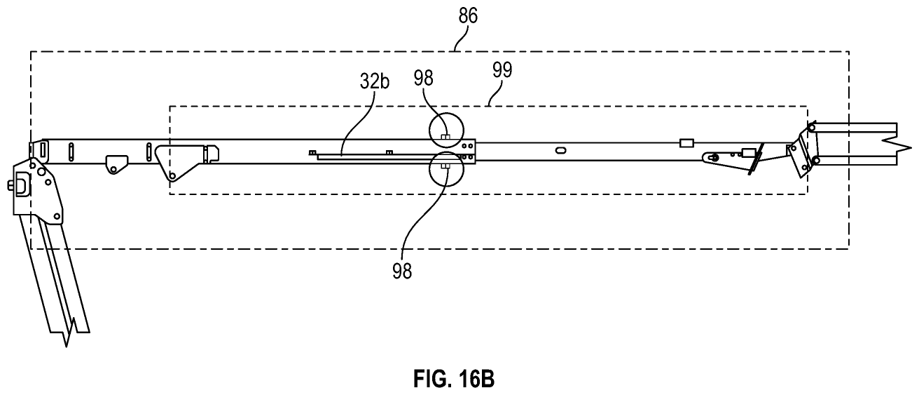

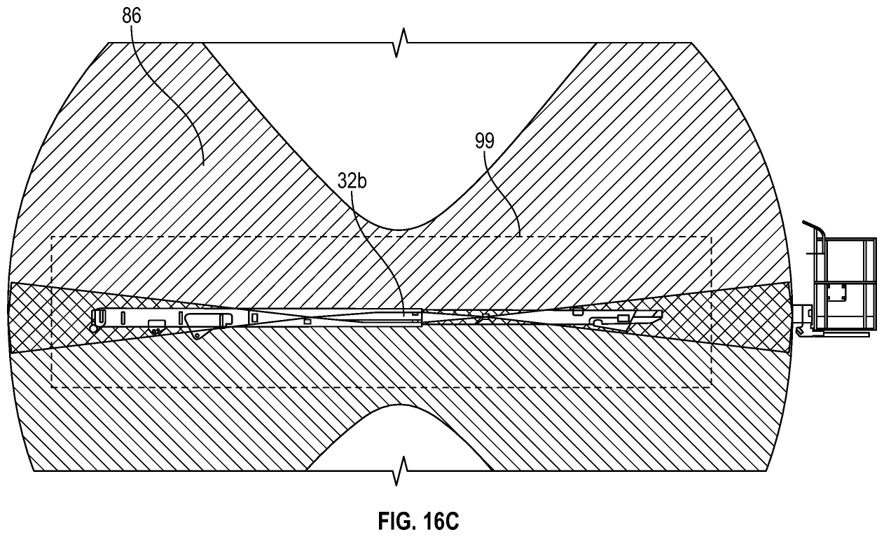

Referring to FIG. 16A, a plurality of sensors 98 may be disposed on the lift assembly 14 (e.g., medial lift arm 32b, lower lift arm 32a) to monitor an area surrounding the lift assembly 14 and the base assembly 12 for obstacles. The sensors 98 may be positioned on the lift arms 32 and/or the mounts 40 of the lift arms 32. According to an exemplary embodiment, the lift assembly 14 has six sensors 98: a first sensor 98 on a top surface of the medial lift arm 32b, a second sensor 98 on a bottom surface of the medial lift arm 32b, a third sensor 98 on a front portion of a first mount 40, a fourth sensor 98 on a rear portion of the first mount 40, a fifth sensor 98 on a front portion of a second mount 40, and a sixth sensor 98 on a front portion of the second mount 40. In other embodiments, there may be a different number of sensors 98 and/or a different arrangement of sensors 98 on the lift assembly 14.

Referring to FIGS. 16B and 16C, the sensors 98 on the medial lift arm 32b may allow for monitoring of a protected volume 99 around the medial lift arm 32b. In some embodiments, the medial lift arm 32b is a telescoping boom capable of extending and/or retracting between a fully extended state, a fully retracted state, and a plurality of intermediate states (e.g., between the fully extended state and the fully retracted state). The sensors 98 may allow for monitoring of a dynamically adjustable medial lift arm 32b. For example, the sensors 98 may allow for monitoring of a protected volume that extends a vertical distance of two feet away from the medial lift arm 32b (e.g., in an upward and/or downward direction), and extends a horizontal distance across the medial lift arm 32b (e.g., in a fully retracted state, in a fully extended state, in an intermediate state). The sensors 98 on the medial lift arm 32b may have a field of view 86 that extends an entire length of the medial lift arm 32b. The field of view 86 may include the protected volume 99. In some embodiments, the medial lift arm 32b includes one or more ultrasonic sensors embedded in the telescoping boom configured to monitor the area around the telescoping boom when exposed (e.g., in an expanded state). For example, in a retracted state, the embedded sensors may not monitor a surrounding environment, but in the expanded state, the embedded sensors are exposed and may monitor the surrounding environment.

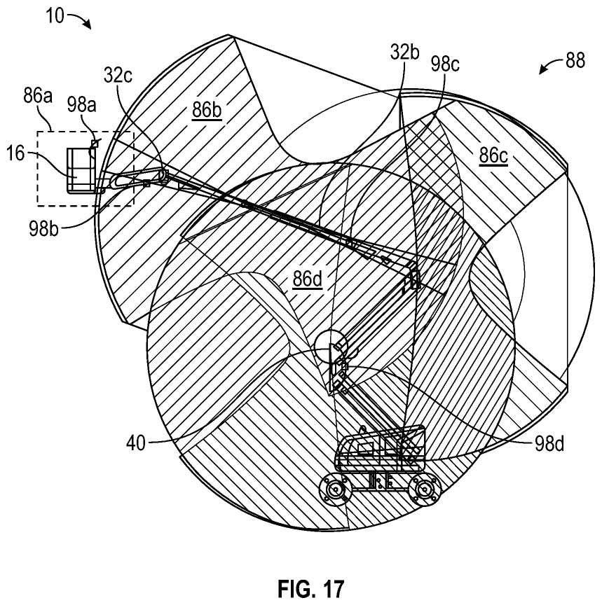

Referring to FIG. 17, the field of view 86 of each sensor disposed on the lift device 10 may combine into an overall field of view 88. The overall field of view 88 may be based on the placement (e.g., arrangement) of the sensors on the lift device 10. For example, the overall field of view 88 may include a first field of view 86a corresponding to a first group of sensors 98a (e.g., of the platform assembly 16), a second field of view 86b corresponding to a second group of sensors 98b (e.g., of the jib 32c), a third field of view 86c corresponding to a third group of sensors 98c (e.g., of the medial lift arm 32b), and a fourth field of view 86d corresponding to a fourth group of sensors 98d, (e.g., of a mount 40). In some embodiments, the overall field of view 88 may extend a single distance away from the lift device 10 across the entire lift device 10. In other embodiments, the extension of overall field of view 88 from the list device varies across different components of the lift device 10. For example, the overall field of view 88 may extend one foot from the platform assembly 16, and may extend two feet from the medial lift arm 32b.

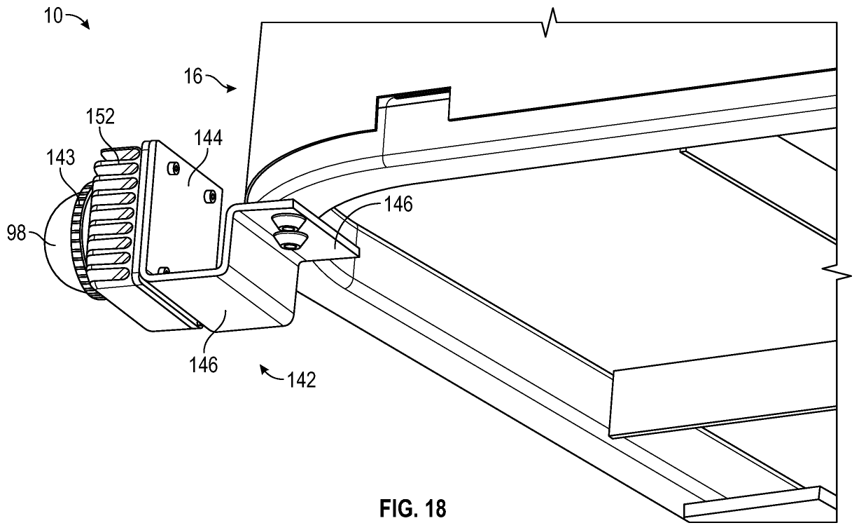

Referring to FIG. 18, the sensors 98 may be either fixedly (e.g., rigidly) coupled or pivotably (e.g., rotatably) coupled to the lift device 10. In some embodiments, the sensors 98 are configured to allow the sensor to pivot relative to the surface of the lift device 10. For example, the sensors 98 may be coupled to gimbals that allow the sensor 98 to pivot responsive to movement of the lift device and/or responsive to movement caused by an actuator. In some embodiments, the sensors 98 are fixedly coupled to the lift device 10 by a bracket 142. The bracket 142 may be any shape or size that allows coupling of the sensor 98 to the lift device 10. According to an exemplary embodiment, the bracket 142 has a first flat surface 144 for coupling to the sensor 98. The bracket 142 is shown to have a curved portion 146 that connects the first flat surface 144 to a second flat surface 148. The first flat surface 144 may be approximately parallel to the surface of the lift device 10, and the second flat surface 148 may be approximately perpendicular to the first flat surface 144. In some embodiments, the bracket 142 is configured to couple the sensor 98 to the underside of the platform assembly 16. The bracket 142 may include a flange 143 for securing the sensor 98 to the bracket 142. The size of the flange 143 may be based on the size of the sensor 98 it is configured to accept. The bracket 142 may include a heat sink 152 positioned between the flange and the first flat surface 144 configured to dissipate heat generated by the sensor 98.

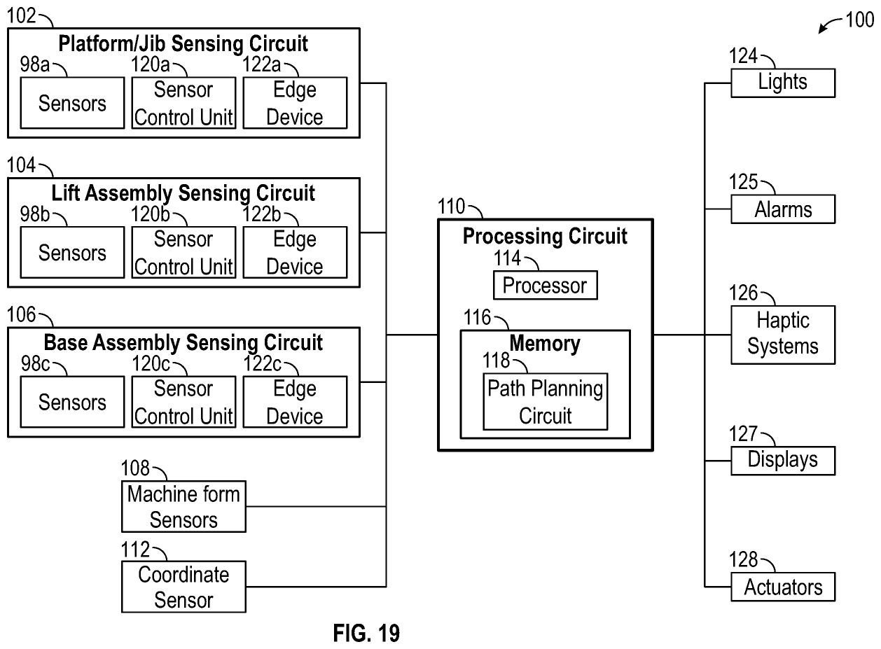

Referring to FIG. 19, depicted is the obstacle detection system 100. The obstacle detection system 100 may be configured to plan a path for the lift device 10 based on detected obstacles. The obstacle detection system 100 may include a processing circuit 110 to control displays, lights, actuators, alarms, haptic systems, and/or other features of the lift device 10 based on the planned path and/or detected obstacles to allow for operation of the lift device without collision (e.g., interaction) with detected obstacles.

The obstacle detection system 100 is shown to include a platform/jib sensing circuit 102. The platform/jib sensing circuit 102 may include a first group of sensors 98a disposed (e.g., positioned, arranged) on the platform assembly 16 and/or the jib 32c. The first group of sensors 98a may be LiDAR sensors, ultrasonic sensors, cameras, IMUs, and/or any other type of sensor. The platform/jib sensing circuit 102 may include a sensor control unit 120a configured to control and/or monitor the first group of sensors 98a. For example, if the sensors 98a are pivotably coupled to the platform assembly 16 or the jib 32c, the sensor control unit 120a may adjust the position of the sensors 98a. As another example, if the sensors 98a are set (e.g., programmed) to detect obstacles within a first distance from the platform assembly 16 and/or the jib 32c, the sensor control unit 120a may adjust the sensors 98a to detect obstacles within a second distance from the platform assembly 16 and/or the jib 32c. As yet another example, the sensor control unit 120a may monitor an operational status of each of the sensors 98a to ensure that the sensors are functioning properly. The platform/jib sensing circuit 102 may include an edge device 122a to transmit (e.g., send, provide) data from the sensors to the processing circuit 110. For example, the edge device 122a may provide an indication to the processing circuit 110 of any detected obstacles. The edge device 122a may provide information regarding the detected obstacles, such as an approximate location of the obstacle, and a distance between the platform assembly 16 and/or jib 32c and the obstacle.

The obstacle detection system 100 is shown to include a lift assembly sensing circuit 104. The lift assembly sensing circuit 104 may include a second group of sensors 98b disposed (e.g., positioned, arranged) on the lift assembly 14 (e.g., excluding the jib 32c). The second group of sensors 98b may be LiDAR sensors, ultrasonic sensors, cameras, IMUs, and/or any other type of sensor. The lift assembly sensing circuit 104 may include a sensor control unit 120b configured to control and/or monitor the second group of sensors 98b. For example, if the sensors 98b are pivotably coupled to the lift assembly 14, the sensor control unit 120b may adjust the position of the sensors 98b. As another example, if the sensors 98b are set (e.g., programmed) to detect obstacles within a first distance from the lift assembly 14, the sensor control unit 120b may adjust the sensors 98b to detect obstacles within a second distance from the lift assembly 14. As yet another example, the sensor control unit 120b may monitor an operational status of each of the sensors 98b to ensure that the sensors are functioning properly. The lift assembly sensing circuit 104 may include an edge device 122b to transmit (e.g., send, provide) data from the sensors to the processing circuit 110. For example, the edge device 122b may provide an indication to the processing circuit 110 of any detected obstacles. The edge device 122b may provide information regarding the detected obstacles, such as an approximate location of the obstacle, and a distance between the lift assembly 14 and the obstacle.

The obstacle detection system 100 is shown to include a base assembly sensing circuit 106. The base assembly sensing circuit 106 may include a third group of sensors 98c disposed (e.g., positioned, arranged) on the base assembly 12. The third group of sensors 98c may be LiDAR sensors, ultrasonic sensors, cameras, IMUs, and/or any other type of sensor. The base assembly sensing circuit 106 may include a sensor control unit 120c configured to control and/or monitor the third group of sensors 98c. For example, if the sensors 98c are pivotably coupled to the base assembly 12, the sensor control unit 120c may adjust the position of the sensors 98c. As another example, if the sensors 98c are set (e.g., programmed) to detect obstacles within a first distance from the base assembly 12, the sensor control unit 120c may adjust the sensors 98c to detect obstacles within a second distance from the lift assembly 14. As yet another example, the sensor control unit 120c may monitor an operational status of each of the sensors 98c to ensure that the sensors are functioning properly. The base assembly sensing circuit 106 may include an edge device 122c to transmit (e.g., send, provide) data from the sensors to the processing circuit 110. For example, the edge device 122c may provide an indication to the processing circuit 110 of any detected obstacles. The edge device 122c may provide information regarding the detected obstacles, such as an approximate location of the obstacle, and a distance between the base assembly 12 and the obstacle.

The obstacle detection system 100 is shown to include a plurality of machine form sensors 108. The machine form sensors 108 may be sensors configured to detect information regarding a configuration of the lift device 10. The machine form sensors 108 may include a jib angle sensor configured to measure (e.g., detect) an angle between the jib 32c relative to the lift assembly 14. The machine form sensors 108 may include a boom angle sensor configured to determine the angle of lift arms 32 relative to the work surface (e.g., ground) and/or an elevation of the lift arms 32. The machine form sensors 108 may include other sensors configured to detect configuration information of the lift device 10, such as arm extension sensors, elevation sensors, and/or other sensors. The machine form sensors 108 may transmit (e.g., send, provide) sensor data to the processing circuit 110.

The obstacle detection system 100 is shown to include a coordinate sensor 112 to detect or otherwise identify a location of the lift device on the work surface (e.g., ground). The coordinate sensor 112 may be continuously providing updates to the processing circuit 110 regarding the coordinates of the lift device 10, such that the processing circuit 110 can determine a location of the lift device 10. The coordinate sensor 112 may provide geographical coordinates to the processing circuit 110, and/or may provide coordinates based on a mapping of the work surface. By way of example, the coordinate sensor 112 may include a global positioning system (GPS) receiver, an IMU, or another type of position sensor.

The processing circuit 110 is shown to include one or more processors 114 and memory 116, which can be implemented as one or more processing circuits. The processor 114 may be a general purpose or specific purpose processor, an application specific integrated circuit (ASIC), one or more field programmable gate arrays (FPGAs), a group of processing components, or other suitable processing components. The processor 114 may execute computer code or instructions stored in memory 116 (e.g., fuzzy logic, etc.) or received from other computer readable media (e.g., CDROM, network storage, a remote server, etc.) to perform one or more of the processes described herein.

The memory 116 may include one or more data storage devices (e.g., memory units, memory devices, computer-readable storage media, etc.) to store data, computer code, executable instructions, or other forms of computer-readable information. The memory 116 may include random access memory (RAM), read-only memory (ROM), hard drive storage, temporary storage, non-volatile memory, flash memory, optical memory, or any other suitable memory for storing software objects and/or computer instructions. The memory 116 may include database components, object code components, script components, or any other type of information structure for supporting the various activities and information structures described in the present disclosure. The memory 116 may be communicably connected to the processor 114 and may include computer code for executing (e.g., by processor 114) one or more of the processes described herein. The memory 116 can include various modules (e.g., circuits, engines) for completing processes described herein. The one or more processors 114 and memory 116 may include various distributed components that may be communicatively coupled by wired or wireless connections; for example, various portions of the obstacle detection system 100 may be implemented using one or more user devices remote from one or more server devices. The memory 116 can include any one or more rules, heuristics, logic, code, functions, machine learning models, neural networks, algorithms, or various combinations thereof to implement one or more components of the obstacle detection system 100.

The memory 116 is shown to include a path planning circuit 118. The processing circuit 110 may receive sensor data associated with the sensors 98a-98c, machine form sensors 108, and/or the coordinate sensor 112. If an obstacle is detected by one or more sensors, the path planning circuit 118 may determine a path for the lift device 10 to travel to avoid the obstacle. In some embodiments, the path planning circuit 118 may determine the path responsive to detection of the obstacle. In some embodiments, the path planning circuit 118 may determine the path responsive to the obstacle being detected within a threshold distance of the lift device 10.

The path planning circuit 118 may determine, based on data from the sensors 98a-98c, machine form sensors 108, and the coordinate sensors 112, an approximate location of the obstacle. For example, the path planning circuit 118 may calculate (e.g., triangulate) a distance from a respective sensor 98 to the obstacle, determine an approximate elevation of the respective sensor 98 based on data from the machine form sensors 108, and determine an approximate coordinate of the respective sensor 98 based on data from the coordinate sensor 112. From this, the path planning circuit 118 can determine an approximate location of the obstacle, as well as configuration information regarding the lift device 10.

The path planning circuit 118 may determine an optimal path for the lift device 10 to avoid collision (e.g., interaction) with the obstacle. For example, the path planning circuit 118 may determine whether actuators of the lift device 10 should be operated to move the lift device 10 on the work surface and/or move components of the lift device (e.g., lift arms 32, platform assembly 16, etc.) away from the obstacle. The optimal path may be based on the determined location of the obstacle and/or the configuration information of the lift device 10. For example, if the obstacle is on the ceiling, and can be avoided by simply lowering a lift arm 32, the optimal path may be to lower the lift arm 32. As another example, if the obstacle is on the work surface, and cannot be avoided without moving around the obstacle, the optimal path may be to move the entire lift device 10 around the obstacle.

The path planning circuit 118 may provide instructions to one or more components of the lift device 10 based on the determined path. In some embodiments, the path planning circuit may notify the operator regarding the detected obstacle. For example, the processing circuit 110 may transmit a message for display on one or more displays 127 of the lift device 10. The displays 127 may be disposed in the platform assembly 16, such that messages can be viewed by an operator. As another example, the processing circuit 110 may enable a light 124 and/or an alarm 125 to notify the operator regarding the obstacle. As another example, the processing circuit 110 may enable one or more haptic systems 126 to provide a physical indication of the obstacle. The haptic systems 126 may vibrate, provide resistance, and/or provide a different physical indication of the obstacle. For example, if the operator tries to move the platform assembly 16 closer to the obstacle, the haptic system 126 may vibrate to indicate that the platform assembly 16 is moving towards the obstacle.

The path planning circuit 118 may adjust operation of one or more actuators 128 of the lift device 10 based on the determined path. The actuators 128 may include any/all actuators of the lift device, such as the motor 26, actuators 34, extension actuator 35, prime mover 41, turntable motor 44, electric motors 52, and/or other actuators. In some embodiments, the path planning circuit 118 may disable operator controls of certain actuators 128. For example, the path planning circuit 118 may not allow the operator to move the lift device 10 closer to the obstacle. In some embodiments, the path planning circuit 118 may automatically (e.g., autonomously) operate the actuators 128 to move the lift device according to the determined path. The path planning circuit 118 may provide an indication to the operator (e.g., via displays 127, lights 124, alarms 125, haptic systems 126) before initiating automatic operation of the actuators 128.

The processing circuit 110 may continuously monitor the configuration information and sensor data of the lift device 10 while automatically moving the lift device 10 on the determined path. For example, the path planning circuit 118 may determine whether the lift device 10 is following the determined path and/or whether the lift device 10 is successfully avoiding the obstacle. If the determined path is not being followed and/or the lift device 10 is moving closer to the obstacle, the path planning circuit may recalibrate (e.g., based on sensor data) the determined path to be a new determined path, and adjust operation of the actuators 128 to follow the new determined path.

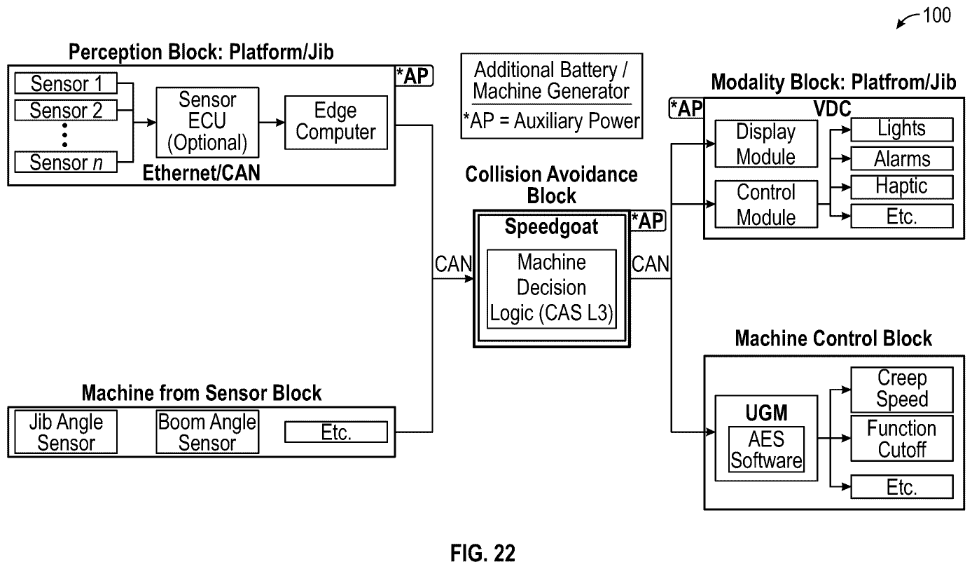

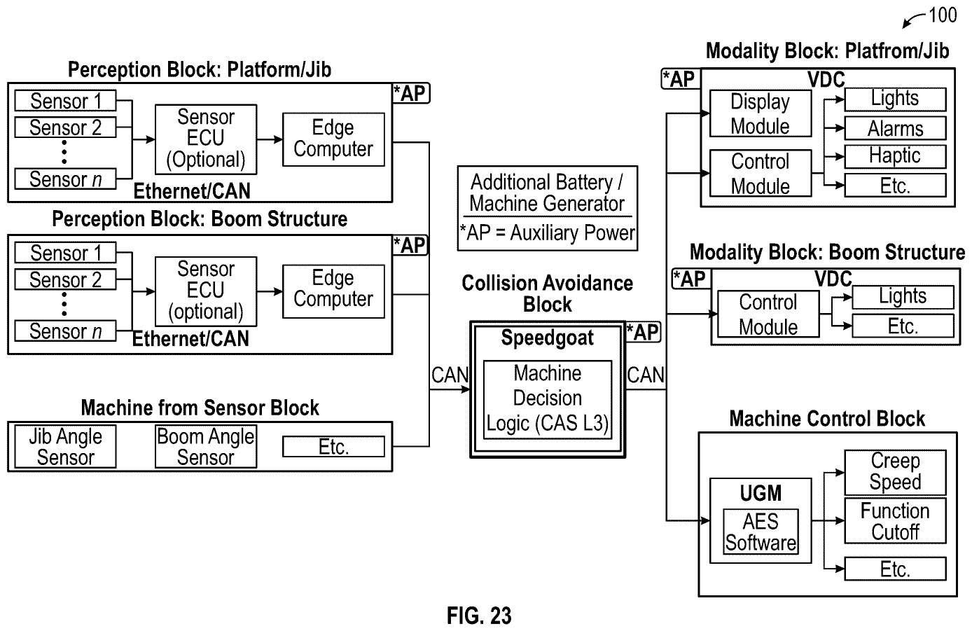

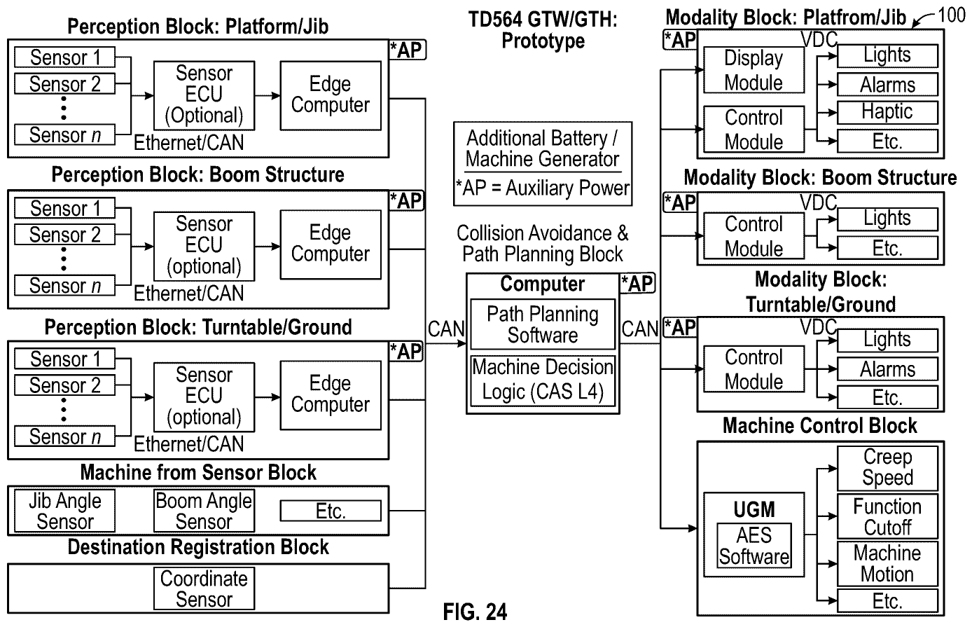

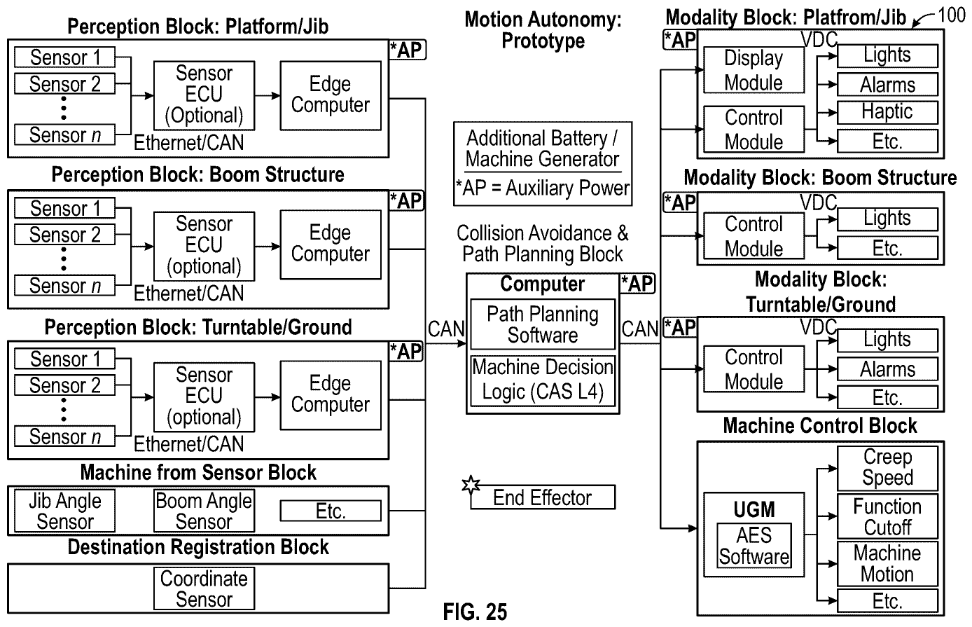

FIGS. 22-25 are additional block diagrams representing obstacle detection systems for a vehicle such as vehicle lift device 10, in same or similar manner as the obstacle detection system 100 shown in FIG. 19.

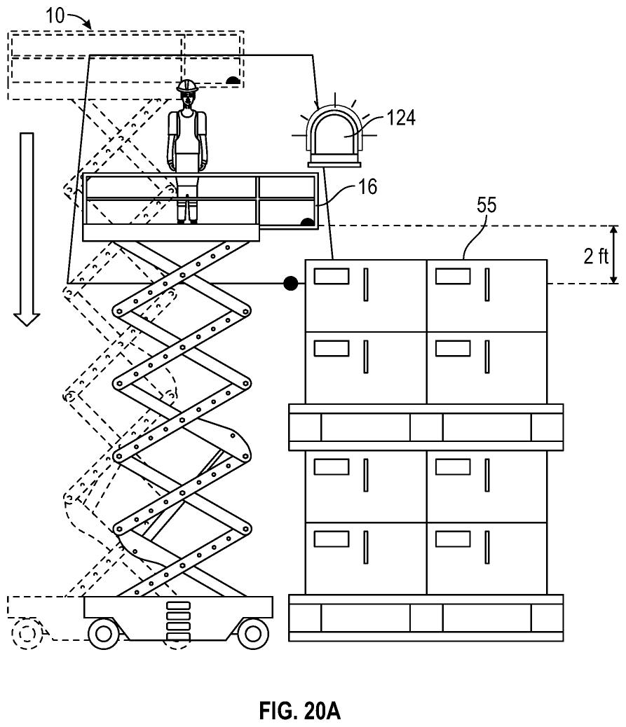

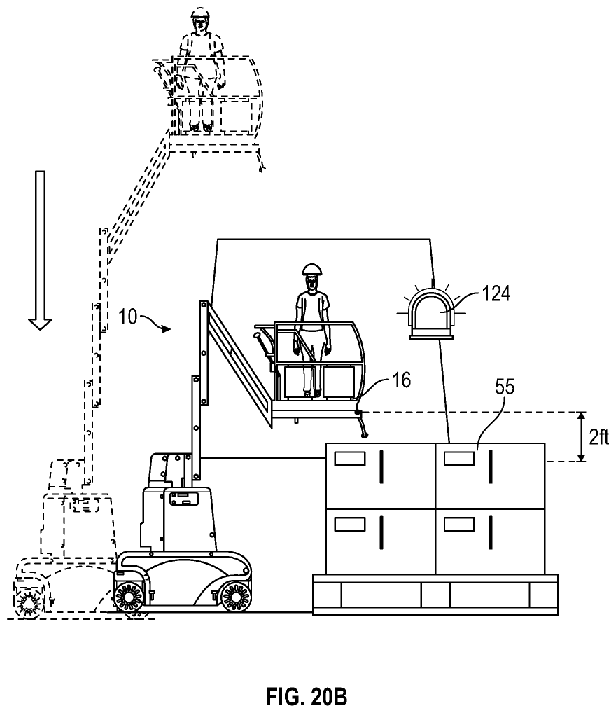

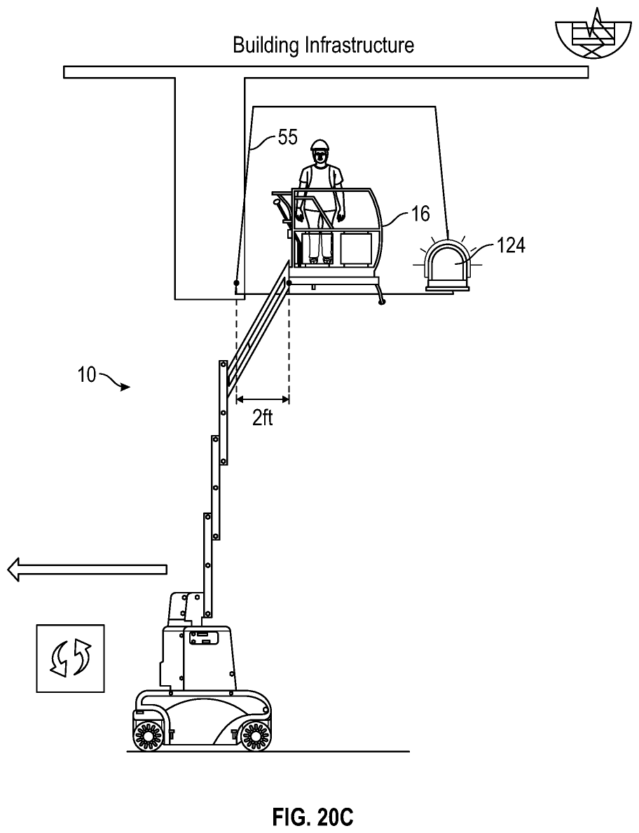

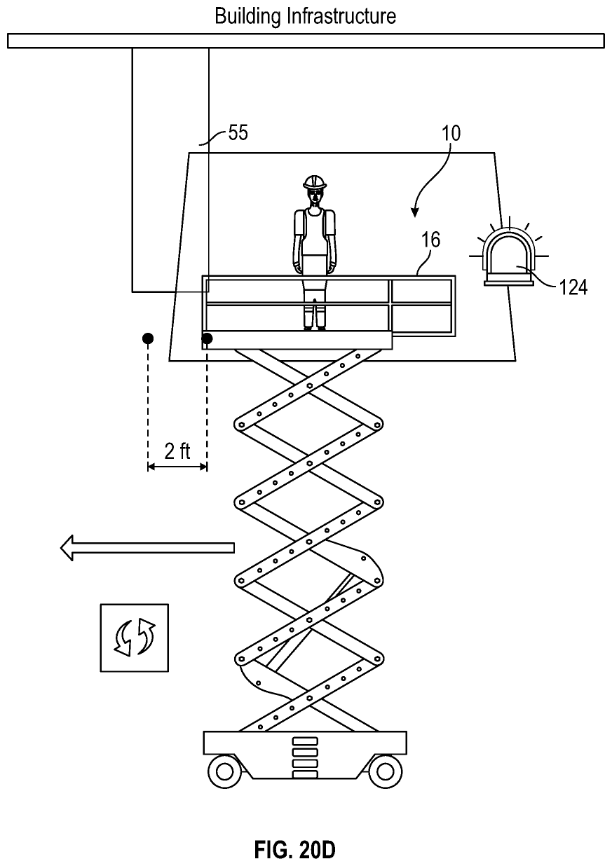

Referring to FIGS. 19, 20A, and 20B, the obstacle detection system 100 may notify operators of the lift device 10 regarding detected obstacles 55 and/or adjust the lift device 10 based on detected obstacles 55. The lift device 10 may be a scissor lift, a boom lift, a telehandler, or a different type of lift. The detected obstacles 55 may be an object that extends from the work surface (e.g., ground). According to an exemplary embodiment, the lift device 10 may move between a raised position and a lowered position. As the lift device 10 is moving towards the lowered position, the platform assembly 16 may be lowered towards an obstacle 55. Once the platform assembly 16 reaches a threshold distance from the obstacle 55, the operator may be notified of the obstacle 55. For example, a light 124 or other indicator may notify the operator of the nearby obstacle 55. Additionally, or alternatively, the obstacle detection system 100 may disable operation of one or more actuators 128 of the lift device 10. For example, the obstacle detection system 100 may disable the operator from lowering the platform assembly 16 until the lift device 10 moves away from the obstacle 55, and the platform assembly 16 is no longer above the obstacle 55.

Referring to FIGS. 19, 20C, and 20D, the obstacle detection system 100 may notify operators of the lift device 10 regarding detected obstacles 55 and/or adjust the lift device 10 based on detected obstacles 55. The lift device 10 may be a scissor lift, a boom lift, or a different type of lift. The detected obstacles 55 may be an object that extends downward from a ceiling of a building. According to an exemplary embodiment, the lift device 10 may move between a raised position and a lowered position, and translate (e.g., move) along the work surface. As the lift device 10 is moving across the work surface, the platform assembly 16 may be raised at the same height as the obstacle, and the lift device 10 may be moving towards the obstacle 55. Once the platform assembly 16 reaches a threshold distance from the obstacle 55, the operator may be notified of the obstacle 55. For example, a light 124 or different indicator may notify the operator of the nearby obstacle 55. Additionally, or alternatively, the obstacle detection system 100 may disable operation of one or more actuators 128 of the lift device 10. For example, the obstacle detection system 100 may disable the operator moving the lift device 10 along the work surface in the direction of the obstacle 55 until the platform assembly 16 is lowered to be below the obstacle 55.

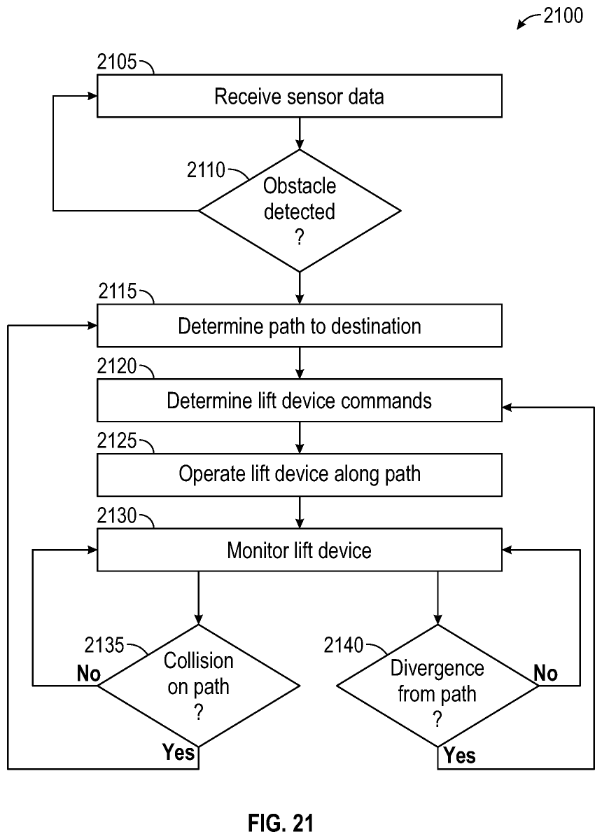

Referring to FIG. 21, depicted is a method 2100 for obstacle detection and path planning. In some embodiments, the method 2100 may be performed or otherwise implemented using components of the obstacle detection system 100. At step 2105, one or more processors may receive sensor data from a plurality of sensors 98 disposed on the lift device 10. The sensors 98 may monitor the environment around the lift device 10 for obstacles. At step 2110, the one or more processors may determine whether an obstacle was detected in the environment surrounding the lift device. If an obstacle was detected, the one or more processors may determine configuration information and/or location information regarding the lift device 10 and/or the obstacle. If no obstacle is detected, the one or more processors may continue to receive sensor data and monitor the environment around the lift device 10.

At step 2115, if an obstacle is detected, the one or more processors may determine a path from the current location of the lift device 10 to a desired destination of the lift device. In some embodiments, the path may be based on the shortest route from the current location to the destination. In some embodiments, the path may be a path that reaches the destination while avoiding the obstacle. At step 2120, the one or more processors may determine one or more commands for the lift device 10 (e.g., actuators 128 of the lift device) to follow the path to the destination without colliding with (e.g., interacting with) the obstacle. In some embodiments, the commands may include raising and/or lowering the lift device 10, moving the tractive elements of the lift device 10, and/or performing other operations of the lift device 10. The one or more processors may determine time(s) and/or location(s) for the execution of the one or more commands.

At step 2125, the one or more processors may autonomously operate the lift device 10 along the path. For example, the one or more processors may execute the commands for the actuators of the lift device at the determined time(s) and/or location(s). At step 2130, the one or more processors may receive additional sensor data to continuously monitor the lift device 10 as the lift device 10 moves along the path. For example, the one or more processors may monitor for obstacles, and to ensure that the lift device 10 is following (e.g., moving along) the determined path.

At step 2135, the one or more processors may determine whether there is a collision on the path between the lift device 10 and an obstacle. If there is a collision on the path, the one or more processors may determine a new path to the destination, determine new lift device 10 commands, operate the lift device 10 along the new path, and continue to monitor the lift device 10 for additional collisions (e.g., as shown in steps 2120-2135). If no collision is detected, the one or more processors may continue to monitor the lift device 10 as it moves along the path until it reaches its destination. At step 2140, the one or more processors may determine whether the lift device 10 diverged (e.g., deviated, left) from the path. If the lift device 10 diverged from the path, the one or more processors may determine one or more new lift device commands for re-entering the path, operate the lift device 10 along the path, and continue to monitor for further divergences (e.g., as shown in steps 2120-2140). If the lift device 10 did not diverge from the path, the one or more processors may continue to monitor the lift device 10 for divergences until the lift device 10 reaches its destination.

### Configuration of the Exemplary Embodiments

As utilized herein with respect to numerical ranges, the terms “approximately,” “about,” “substantially,” and similar terms generally mean +/-10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure.

It is important to note that the construction and arrangement of the lift device 10 and obstacle detection system 100 as shown in the various exemplary embodiments is illustrative only. Additionally, any element disclosed in one embodiment may be incorporated or utilized with any other embodiment disclosed herein. For example, the techniques of the platform sensors 98 of the exemplary embodiment shown in at least FIG. 6 may be incorporated in the lift device 10 of the embodiment shown in at least FIG. 11A. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. An obstacle detection system comprising:
a lift device including:
a chassis;
a drivetrain coupled to the chassis and configured to propel the lift device;
an implement;
a lift assembly coupled to the chassis and the implement, the lift assembly configured to raise the implement relative to the chassis; and
a sensor; and
one or more processing circuits configured to:
receive sensor data from the sensor;
detect an obstacle near the lift device based on the sensor data;
determine, responsive to the obstacle being near the lift device, a path to a destination for the lift device that avoids interacting with the obstacle; and
control at least one of the drivetrain or the lift assembly to move the lift device on the path to the destination.

2. The obstacle detection system of claim 1, wherein:
the implement is a platform configured to support an operator, the platform including a railing;
the sensor is a first LiDAR sensor coupled to the railing of the platform of the lift device and positioned to detect the obstacle above the platform; and
the lift device further includes a second LiDAR sensor coupled to an underside of the platform and positioned to monitor an area below the platform.

3. The obstacle detection system of claim 1, wherein the implement is a platform including a telescopic rod coupled to the sensor, wherein the sensor is configured to detect the obstacle above the platform, and wherein a length of the telescopic rod is adjustable to vary a height of the sensor.

4. The obstacle detection system of claim 1, wherein the sensor is a first sensor, further comprising a wearable device including a second sensor, and wherein the second sensor is configured to detect the obstacle above a platform of the lift device.

5. The obstacle detection system of claim 1, wherein the implement is a platform configured to support an operator, wherein the sensor is pivotably coupled to the platform, wherein the sensor includes an actuator that is configured to move the sensor relative to the platform, and wherein the one or more processing circuits are configured to control the actuator to adjust a field of view of the sensor in response to a movement of the lift assembly.

6. The obstacle detection system of claim 1, wherein the lift assembly includes a boom assembly coupled to the implement, and wherein the sensor is coupled to the boom assembly and configured to monitor an area around the boom assembly.

7. The obstacle detection system of claim 6, wherein the sensor is an ultrasonic sensor positioned such that the area around the boom assembly that is monitored by the sensor moves relative to the implement when the boom assembly is extended.

8. The obstacle detection system of claim 1, wherein the implement is a platform configured to support an operator, wherein the lift assembly includes a boom assembly and a platform rotator coupled to the boom assembly and configured to cause rotation of the platform relative to the boom assembly, wherein the sensor is an ultrasonic sensor coupled to the platform rotator, and wherein the ultrasonic sensor is configured to monitor an area below the platform.

9. The obstacle detection system of claim 1, wherein the implement is a platform configured to support an operator, wherein the sensor is a camera coupled to the platform and configured to provide first sensor data, wherein the lift device further includes an inertial measurement unit (IMU) coupled to the platform and configured to provide second sensor data, and wherein the one or more processing circuits are configured to determine a location of the obstacle based on the second sensor data from the IMU.

10. A lift device, comprising:
a base assembly configured to propel the lift device;
a lift assembly coupled to the base assembly;
a platform assembly coupled to the lift assembly and including a rail coupled to a deck, wherein the lift assembly is configured to raise the platform assembly relative to the base assembly;
a first sensor coupled to the rail and configured to detect a first obstacle;
a second sensor coupled to the deck and configured to detect a second obstacle; and
a controller operatively coupled to the first sensor and the second sensor and configured to:
receive a command to control at least one of the base assembly or the lift assembly to move the lift device along a first path;
determine a second path for the lift device that is different from the first path in response to at least one of (a) the first sensor detecting the first obstacle or (b) the second sensor detecting the second obstacle; and
control at least one of the base assembly or the lift assembly to move the lift device along the second path.

11. The lift device of claim 10, further comprising a third sensor pivotably coupled to the platform assembly, wherein the third sensor includes an actuator configured to move a field of view of the third sensor relative to the platform assembly.

12. The lift device of claim 11, wherein the controller is configured to control the actuator to move the field of view of the third sensor based on a direction of motion of the lift device.

13. The lift device of claim 11, further comprising a lift device configured to receive a user interaction, and wherein the controller is configured to control the actuator to move the field of view based on the user interaction.

14. The lift device of claim 10, further comprising:
a third sensor coupled to the platform assembly and positioned such that a field of view of the third sensor extends horizontally outward from the platform assembly; and
a fourth sensor coupled to the lift assembly and configured to monitor an area including the platform assembly.

15. The lift device of claim 10, wherein at least one of the first sensor or the second sensor is a LiDAR sensor.

16. The lift device of claim 10, wherein the platform assembly further includes a telescopic rod coupled to the rail and the first sensor, and wherein a length of the telescopic rod is adjustable to vary a distance between the first sensor and the deck.

17. A method, comprising:
receiving, by one or more processing circuits, sensor data from one or more sensors disposed on a lift device;
detecting, by the one or more processing circuits, an obstacle near the lift device based on the sensor data;
determining, by the one or more processing circuits, responsive to the obstacle being near the lift device, a path to a destination for the lift device that avoids interacting with the obstacle; and
monitoring, by the one or more processing circuits, the lift device to determine whether there is a collision on the path between the lift device and the obstacle or another obstacle.

18. The method of claim 17, further comprising monitoring, by the one or more processing circuits, a travel distance of a platform of the lift device.

19. The method of claim 17, further comprising determining, by the one or more processing circuits, a location of the lift device.

20. The method of claim 17, further comprising:
extending, by the one or more processing circuits, a boom structure of the lift device, wherein the boom structure is coupled to a platform of the lift device; and
monitoring, by the one or more processing circuits, sensor data from an ultrasonic sensor of the one or more sensors disposed on the boom structure.
